(19) United States
(12) Patent Application Publication
(10) Pub. No.: US 2026/0134390 A1
(43) Pub. Date: May 14, 2026

(54) WAREHOUSE MANAGEMENT SYSTEM

(71) Applicant: Wesco Digital Solutions (Ireland) Limited, Dublin 2 (IE)

(72) Inventors: Keith Patel, Keystone, CO (US); Scott Ramsbottom, Oswego, IL (US); Eric Farris, Weatherford, TX (US); Edward Galster, Chicago, IL (US); Mike Coleman, Glenview, IL (US)

(73) Assignee: Wesco Digital Solutions (Ireland) Limited, Dublin 2 (IE)

(21) Appl. No.: 19/379,548

(22) Filed: Nov. 4, 2025

Related U.S. Application Data
(63) Continuation-in-part of application No. PCT/EP2025/055117, filed on Feb. 26, 2025.
(60) Provisional application No. 63/720,227, filed on Nov. 14, 2024.
(60) Provisional application No. 63/720,227, filed on Nov. 14, 2024.

(51) Int. Cl. G06Q 10/087; G06Q 10/0631

(52) U.S. Cl. CPC G06Q 10/08744; G06Q 10/063114; G06Q 10/06316; G06Q 10/08724; G06Q 10/08741

(57) ABSTRACT

This disclosure describes a computer-implemented method for efficiently managing warehouse operations by dynamically controlling tasks across multiple facilities. Upon receiving data related to a customer order, the system processes task sequences based on order-specific criteria such as delivery deadlines, product requirements, and inventory availability. A data processing module extracts order parameters and, through an orchestration module, adjusts the task sequence in real-time, addressing inventory levels, resource constraints, and operational conditions. The method leverages predictive analytics, historical data, and integration with external systems to optimize task assignment, ensuring efficient fulfillment. Additionally, the system can modify tasks based on customer preferences and environmental impact metrics, reallocating resources as needed to maintain operational continuity. This adaptable approach enhances warehouse flexibility, enabling tasks to be customized for unique orders, cross-docking processes, and specific customer requirements while minimizing delays and optimizing resource use.

### CROSS REFERENCE TO RELATED APPLICATIONS

This application claims the benefit of U.S. Provisional Patent Application No. 63/720,227, filed on Nov. 14, 2024, under the provisions of 35 U.S.C. § 119(e). The entire disclosure of U.S. Provisional Patent Application No. 63/720,227 is incorporated by reference herein.

This application is a continuation-in-part of International Application No. PCT/EP2025/055117, filed on Feb. 26, 2025, which is entitled to the benefit of U.S. Provisional Patent Application No. 63/720,227, filed on Nov. 14, 2024. This application is filed under the provisions of 35 U.S.C. § 111(a) and claims the benefit of the filing date of International Application No. PCT/EP2025/055117 under 35 U.S.C. § 120 and § 365(c) for common subject matter. The entire disclosure of International Application No. PCT/EP2025/055117 is incorporated by reference herein.

### TECHNICAL FIELD

The present disclosure relates to warehouse management systems (WMS), particularly a cloud-based WMS capable of dynamic task orchestration, real-time inventory management, multi-level component tracking, integration of light manufacturing processes, and artificial intelligence (AI)-based task optimization for improved warehouse efficiency.

### BACKGROUND

Traditional warehouse management systems face several limitations, including their inability to handle complex, custom, or dynamic workflows, lack dynamic task management, lack of AI-driven optimization, inefficient inventory tracking, lack scalability, and challenges in integrating value-added services like light manufacturing. Furthermore, conventional warehouse management systems fall short in supporting custom processes or unique business needs, especially in industries requiring multi-level component assembly tracking and rigorous traceability of serialized or lot-controlled items (e.g., aerospace, automotive, and electronics sectors). These shortcomings lead to inefficiencies in inventory management, task allocation, and order fulfillment, especially when operating across multiple warehouse locations.

### SUMMARY

The present disclosure describes various embodiments of a warehouse management system to dynamically generate and manage tasks based on real-time warehouse conditions, order specifics, and inventory availability. In one embodiment, the warehouse management system integrates advanced features such as AI-driven optimization, multi-level component tracking, and support for light manufacturing processes such as cable cutting, assembly, and custom labeling. In one embodiment, the warehouse management system ensures seamless scalability across multiple warehouse locations, allowing for centralized control and improved operational efficiency. In one embodiment, the warehouse management system employs cloud-based scalability enabling both on-premise and cloud-based operations with centralized control over multiple warehouses and global scalability.

In a first embodiment, the present disclosure describes a computer-implemented method for controlling operations within one or more warehouse facilities. An input data module receives an inbound data packet containing data parameters related to a customer order of physical goods stored in one or more warehouse facilities. A data processing module processes the inbound data packet to manage order fulfillment. The data processing module extracts data parameters regarding the physical goods specified in the customer order. The data processing module analyzes the extracted data parameters for determining a sequenced set of physical tasks required for fulfilling the customer order, with each task allocating specific warehouse resources for operations. The sequenced set of physical tasks may include automated light manufacturing tasks executable by the corresponding allocated warehouse resources. The data processing module directs the sequenced set of physical tasks to specific warehouse facilities configured to execute and monitor task progress through operational data feedback. An orchestration module in communication with the data processing module orchestrates the execution of tasks in response to operational data from the warehouse facilities, for fulfilling the customer order by dynamically reallocating resources among physical tasks based on operational changes in the operational data to adjust physical task execution in real-time.

In conjunction with one or more embodiments of the first embodiment, the automated light manufacturing tasks comprise one or more of cutting, stripping, twisting, printing, dipping, and multi-level component assembly, and wherein the orchestration module controls execution of the automated light manufacturing tasks by transmitting machine-specific control signals to automated machines via programmable logic controller (PLC) interfaces.

In conjunction with one or more embodiments of the first embodiment, the parameters of the inbound data packet include order customization specifications for the customer order. The method may include determining the automated light manufacturing tasks based on the customization specifications, validating the determined automated light manufacturing tasks against automated machine capabilities and availability, constructing a dependency graph mapping inter-task dependencies between the validated automated light manufacturing tasks, and determining the sequenced set of physical tasks based on the dependency graph.

In conjunction with one or more embodiments of the first embodiment, the method may include applying a batching heuristic to group automated light manufacturing tasks across multiple customer orders based on shared customization specifications, wherein the batching heuristic uses cosine similarity on vectorized order features and determining the sequenced set of physical tasks based on the batching heuristic to minimize automated machine setting changes between execution of tasks across the multiple orders.

In conjunction with one or more embodiments of the first embodiment, the automated machines controlled by the orchestration module include any one or more of an automated computer numerical control (CNC) cutter for cutting tasks, a laser cutting machine for cutting tasks, an automated wire stripping machine for stripping tasks, an automated twisting machine for automated twisting tasks, an automated inkjet machine for printing tasks, an automated laser marking machine for printing tasks, an automated immersion dipping machine for dipping tasks, a robotic arm for multi-level component assembly tasks, and automated guided vehicles for for multi-level component assembly tasks.

In conjunction with one or more embodiments of the first embodiment, the method may include obtaining, by the orchestration module, the operational data from one or more sensors configured to monitor execution of the automated light manufacturing tasks by the automated machines and detecting, by the orchestration module, an operational issue associated with execution of an automated light manufacturing task based on the operational data. The method may include dynamically modifying execution of the automated light manufacturing tasks associated with the operational issue in-real time to mitigate the operational issue. Dynamically modifying the execution may include modifying an operational parameter of the automated machine executing the automated light manufacturing task associated with operational issue or allocating a different automated machine to the automated light manufacturing task associated with operational issue.

In conjunction with one or more embodiments of the first embodiment, the method may include adjusting, by the orchestration module, the sequence of physical tasks determined by the data processing module before directing the sequenced set of physical tasks to the specific warehouse facilities for execution based on detecting a conflicting resource allocation with physical tasks associated with another customer order.

In conjunction with one or more embodiments of the first embodiment, the method may include initiating, by the orchestration module, a startup sequence for one or more additional automated machines based on detecting a conflicting resource allocation with physical tasks associated with another customer order.

In conjunction with one or more embodiments of the first embodiment, the method may include detecting, by the orchestration module, a triggering event based on the operational data, wherein the triggering event comprises one or more of a new order arrival, a detected anomaly associated with an automated machine, and a threshold breach associated with warehouse resource utilization and applying, by the orchestration module, the operational data to a trained machine learning model to generate a refined task sequence for the sequenced set of physical tasks. The method may include transmitting machine-specific control signals to automated machines to adjust execution of the automated light manufacturing tasks in real-time based on the refined task sequence.

In conjunction with one or more embodiments of the first embodiment, the method may include obtaining, by a inventory optimization engine, dynamic slotting data inputs indicating current inventory levels, past order trends, warehouse layouts, and performance metrics associated with picker travel distances and generating, by the inventor optimization engine, optimized slot assignments mapping items to physical locations within the warehouse facilities based on applying the dynamic slotting data to a machine learning model. The method may include automatically adjusting, by the orchestration module, inventory positioning within the warehouse facilities based on the optimized slot assignments and determining, by the data processing module, the sequenced set of physical tasks based on the adjusted inventory positioning.

In conjunction with one or more embodiments of the first embodiment, the data processing module communicates data with an inventory module. The inventory module monitors inventory levels of the physical goods at one or more warehouse facilities. The inventory module optimizes storage locations of the physical goods and enhances pick-path efficiency. The inventory module traces serialized components through stages of assembly, storage, and shipment.

In conjunction with one or more embodiments of the first embodiment, the inventory module adjusts the sequenced set of physical tasks based on real-time inventory levels at the one or more warehouse facilities, adapting tasks to match current stock availability.

In conjunction with one or more embodiments of the first embodiment, the data processing module generates the sequenced set of physical tasks based on product-specific characteristics including at least one of assembly, labeling, or packaging requirements tailored to each product in the customer order.

In conjunction with one or more embodiments of the first embodiment, the data processing module integrates data from external systems to dynamically adjust the sequenced set of physical tasks, fulfilling the customer order accurately and efficiently.

In conjunction with one or more embodiments of the first embodiment, the data processing module applies predictive analytics based on historical operational data for proactively generating or adjusting the sequenced set of physical tasks to improve efficiency and prevent stock-outs.

In conjunction with one or more embodiments of the first embodiment, the data processing module incorporates cross-docking processes into the sequenced set of physical tasks to directly transfer inbound goods to outbound shipping without intermediate storage, optimizing speed and reducing handling costs.

In conjunction with one or more embodiments of the first embodiment, the data processing module creates the sequenced set of tasks for unique or custom orders that require different fulfillment paths, including coordination with multiple suppliers to provide a tailored and efficient customer order processing.

In conjunction with one or more embodiments of the first embodiment, the data processing module generates the sequenced set of physical tasks based on customizable criteria, including urgency, delivery windows, or product perishability, for dynamically adjusting task execution to meet varying priorities.

In conjunction with one or more embodiments of the first embodiment, the data processing module creates the sequenced set of physical tasks based on supplier availability, lead times, delivery routes, or supplier performance data, for optimizing supplier selection for timely and cost-effective order fulfillment.

In conjunction with one or more embodiments of the first embodiment, the orchestration module adjusts or modifies the sequenced set of physical tasks based on the operational data received from each allocated warehouse facility.

In conjunction with one or more embodiments of the first embodiment, the orchestration module prioritizes tasks in the sequenced set of physical tasks based on customer order-related criteria, including delivery deadlines, product perishability, or order value, to optimize fulfillment efficiency.

In conjunction with one or more embodiments of the first embodiment, the orchestration module allocates tasks in the sequenced set of tasks to specific warehouse facilities based on geographic proximity to a delivery location or customer, for minimizing transportation time and costs.

In conjunction with one or more embodiments of the first embodiment, the orchestration module modifies tasks in the sequenced set of physical tasks based on availability of workforce, equipment, or other operational resources at the warehouse facility, for optimizing capacity and reducing delays.

In conjunction with one or more embodiments of the first embodiment, the orchestration module adjusts or triggers tasks in the sequenced set of physical tasks based on specific events, including stock replenishment, equipment malfunctions, or updates to customer orders.

In conjunction with one or more embodiments of the first embodiment, the orchestration module customizes the sequenced set of physical tasks based on customer-specific preferences or requirements, including at least one of packaging, branding, or handling instructions provided in the inbound data packet

In conjunction with one or more embodiments of the first embodiment, the orchestration module detects failure or delay of a task in the sequenced set of physical tasks at a warehouse facility, and reallocating affected tasks to other warehouse facilities with available capacity or resources for maintaining operational efficiency.

In conjunction with one or more embodiments of the first embodiment, the orchestration module optimizes the sequenced set of physical tasks based on energy consumption metrics, transportation distances, or equipment efficiency, for reducing overall environmental footprint of warehouse operations.

In conjunction with one or more embodiments of the first embodiment, the orchestration module re-prioritizes tasks in the sequenced set of physical tasks based on detected delays or bottlenecks at one or more warehouse facilities to complete critical tasks first and meet customer deadlines.

In conjunction with one or more embodiments of the first embodiment, the orchestration module optimizes the sequenced set of physical tasks based on geographical location of warehouse facilities relative to delivery destinations or supply chain nodes, for minimizing transportation distances and lead times.

In conjunction with one or more embodiments of the first embodiment, the orchestration module allocates tasks in the sequenced set of physical tasks to one or more warehouse facilities based on inventory levels, workforce availability, transportation costs, or energy efficiency.

In conjunction with one or more embodiments of the first embodiment, the orchestration module retrieves operational data from multiple external systems, including Warehouse Management Systems (WMS), Supply Chain Management (SCM) systems, or Enterprise Resource Planning (ERP) systems, for informing task generation and orchestration.

In conjunction with one or more embodiments of the first embodiment, the orchestration module applies forecasting data based on historical operational performance to adjust the sequenced set of tasks based on predictive bottlenecks or resource constraints.

In conjunction with one or more embodiments of the first embodiment, the orchestration module adjusts the sequenced set of physical tasks based on operational data related to equipment efficiency, including at least one of machinery performance metrics or downtime rates, for assigning tasks to the most capable and available equipment.

In conjunction with one or more embodiments of the first embodiment, the orchestration module dynamically reallocates resources including workforce and machinery based on real-time operational data, for continuously optimizing the sequenced set of physical tasks to match available resources at each warehouse facility.

In conjunction with one or more embodiments of the first embodiment, a data output module communicates with the orchestration module automatically generates and transmits notifications to customers regarding order status updates or delays based on operational data from warehouse facilities.

In a second embodiment, the present disclosure describes a system for managing operations across one or more warehouse facilities. An input data module receives inbound data packets containing parameters associated with a customer order for physical goods stored at one or more warehouse facilities. A data processing module processor and memory executes instructions. The data processing module extracts data parameters from the inbound data packets related to the physical goods specified in the customer order. The data processing module analyzes the extracted data to generate a sequenced set of physical tasks needed to fulfill the customer order in which the tasks are allocated to one or more warehouse facilities with each physical task allocating specific warehouse resources for task execution. The sequenced set of physical tasks can include automated physical tasks executable by the corresponding allocated warehouse resources. The data processing module transmits the sequenced set of physical tasks to the warehouse facilities. A plurality of communication interfaces located at each warehouse facility in which the communication interfaces receive the sequenced set of physical tasks from the data processing unit and send operational data, including status updates, back to the data processing unit. An orchestration module receives the operational data and adjusts the sequenced set of physical tasks in response to conditions at the warehouse facilities. A storage system for dynamic storage and retrieval of goods, in communication with the orchestration module and the data processing unit, enables optimization of goods location and retrieval paths within each warehouse facility based on the sequenced set of physical tasks. A tracking system includes sensor arrays and inventory tagging mechanisms, such as RFID or barcode systems, to track serialized components as they move through stages of assembly, storage, and shipment, and to communicate tracked data to the data processing unit.

In conjunction with one or more embodiments of the second embodiment, the automated physical tasks may include light manufacturing such as cable cutting, wire cutting, stripping, printing, and assembly.

In conjunction with one or more embodiments of the second embodiment, a cloud-based control module supports centralized operations across multiple warehouse facilities, enabling remote management, real-time data synchronization, and operational oversight from a single access point.

In conjunction with one or more embodiments of the second embodiment, the data processing module includes a predictive analytics engine analyzes historical data and forecast demand, enabling the orchestration module to proactively adjust the sequenced set of physical tasks to prevent stockouts and optimize resource allocation.

In conjunction with one or more embodiments of the second embodiment, the orchestration module communicates with a workforce management system, assigns physical tasks to available personnel based on workload, proximity to task locations, and efficiency factors.

In conjunction with one or more embodiments of the second embodiment, the input data module receives data from external supply chain systems, including Supplier Management Systems and Logistics Systems, providing the data processing module with supply availability and lead time information to adjust task sequencing.

In conjunction with one or more embodiments of the second embodiment, the storage system with modular storage units can be rearranged dynamically based on real-time inventory demands and repositioned by an automated system to reduce retrieval time for frequently ordered goods.

In conjunction with one or more embodiments of the second embodiment, the tracking system further comprises an energy management module to monitor energy consumption metrics across robotic and mechanical systems within each warehouse, enabling the orchestration module to optimize task sequencing to minimize energy use.

In conjunction with one or more embodiments of the second embodiment, a customer communication module generates automated notifications for customers, providing real-time updates on order fulfillment status based on data received from the warehouse facilities.

In conjunction with one or more embodiments of the second embodiment, a geographical mapping module within the data processing module determines optimal warehouse facility assignments based on customer delivery locations, minimizing transportation time and logistics costs.

In conjunction with one or more embodiments of the second embodiment, a machine learning module is embedded in the data processing module. The machine learning module continuously refines task sequencing based on real-time performance data, historical data, and evolving inventory patterns.

In conjunction with one or more embodiments of the second embodiment, a global load-balancing system dynamically reallocates orders among warehouse facilities based on real-time data from the orchestration module, optimizing warehouse utilization across multiple locations.

In conjunction with one or more embodiments of the second embodiment, a custom order management system communicates with the data processing module. The custom order management system receives customer-specific preferences such as branding and handling instructions and relays this information to the orchestration module.

In conjunction with one or more embodiments of the second embodiment, the data processing module includes an order prioritization engine to determine task urgency based on customer delivery deadlines, order value, or perishability of goods, enabling the orchestration module to allocate resources accordingly.

In conjunction with one or more embodiments of the second embodiment, an integration layer interfaces with third-party enterprise resource planning (ERP) systems, enabling the data processing module to access supplier data, order fulfillment metrics, and transportation schedules, to optimize the generated sequenced set of physical tasks.

In conjunction with one or more embodiments of the second embodiment, the data processing module includes a route optimization module to determine optimal transportation routes for goods leaving each warehouse facility, based on real-time traffic data and logistics schedules.

In conjunction with one or more embodiments of the second embodiment, a human-machine collaboration interface enables warehouse personnel to override an automated sequenced set of physical tasks. The interface is connected to the orchestration module to update the sequenced set of physical tasks in real time.

In conjunction with one or more embodiments of the second embodiment, the data processing module includes a stock-balancing module to synchronize inventory levels across multiple warehouse facilities, triggering stock transfers as needed based on real-time demand and inventory conditions.

In conjunction with one or more embodiments of the second embodiment, an automated load-planning module optimizes product placement on transport vehicles for outbound shipments, minimizing handling and maximizing space efficiency.

In a third embodiment, the present disclosure describes a non-transitory computer-readable medium storing instructions that, when executed by one or more processors of a warehouse management system, cause the warehouse management system to manage operations across one or more warehouse facilities. The instructions cause an input data module to receive inbound data packets containing parameters associated with a customer order of physical goods stored at one or more warehouse facilities, extract data parameters from the inbound data packets related to the physical goods specified in the customer order, and analyze the extracted data to determine a sequenced set of physical tasks required to fulfill the customer order, in which each task is allocated to one or more of the warehouse facilities. The sequenced set of physical tasks may include automated physical tasks executable by warehouse resources at the one or more warehouse facilities. The sequenced set of physical tasks is transmitted to allocated warehouse facilities for execution. Operational data is received from each warehouse facility regarding task status, inventory levels, and order fulfillment progress. The instructions cause an orchestration module to adjust the sequenced set of physical tasks based on the operational data received from the warehouse facilities to improve order fulfillment accuracy and efficiency.

In conjunction with one or more embodiments of the third embodiment, the automated physical tasks may include light manufacturing such as cable cutting, wire cutting, stripping, printing, and assembly.

In conjunction with one or more embodiments of the third embodiment, the instructions cause the one or more processors of the data processing module to communicate data with an inventory module to monitor inventory levels of the physical goods across the warehouse facilities, optimize storage location of physical goods for efficient picking paths, and trace serialized components through stages of assembly, storage, and shipment.

In conjunction with one or more embodiments of the third embodiment, the instructions cause the one or more processors to adjust the sequenced set of physical tasks based on real-time inventory levels at the warehouse facilities, adapting physical tasks to current stock availability.

In conjunction with one or more embodiments of the third embodiment, the instructions cause the one or more processors to generate a sequenced set of physical tasks based on product-specific characteristics, including at least one of assembly, labeling, or packaging requirements tailored to each item in the customer order.

In conjunction with one or more embodiments of the third embodiment, the instructions cause the one or more processors to integrate data from external systems to dynamically adjust the sequenced set of physical tasks to achieve accurate and efficient order fulfillment.

In conjunction with one or more embodiments of the third embodiment, the instructions cause the one or more processors to apply predictive analytics based on historical operational data to proactively generate or adjust the sequenced set of physical tasks to improve efficiency and prevent stock shortages.

In conjunction with one or more embodiments of the third embodiment, the instructions cause the one or more processors to incorporate cross-docking processes into the sequenced set of physical tasks to facilitate direct transfer of inbound goods to outbound shipments, minimizing handling time and storage costs.

In conjunction with one or more embodiments of the third embodiment, the instructions cause the one or more processors to create the sequenced set of physical tasks to manage unique or custom orders requiring different fulfillment paths, including coordination with multiple suppliers for tailored order processing.

In conjunction with one or more embodiments of the third embodiment, the instructions cause the one or more processors to generate the sequenced set of physical tasks based on customizable criteria, including urgency, delivery timeframes, or product perishability, to prioritize task execution according to customer and order requirements.

In conjunction with one or more embodiments of the third embodiment, the instructions cause the one or more processors to create the sequenced set of physical tasks based on supplier availability, lead times, delivery routes, and supplier performance data to optimize supplier selection for timely and cost-effective order fulfillment.

In conjunction with one or more embodiments of the third embodiment, the instructions cause the one or more processors to adjust the sequenced set of physical tasks based on operational data received from allocated warehouse facilities to modify tasks dynamically.

In conjunction with one or more embodiments of the third embodiment, the instructions cause the one or more processors to prioritize tasks in the sequenced set of physical tasks based on criteria such as delivery deadlines, product perishability, or order value to optimize order fulfillment efficiency.

In conjunction with one or more embodiments of the third embodiment, the instructions cause the one or more processors to allocate tasks in the sequenced set of physical tasks to specific warehouse facilities based on their geographic proximity to the customer or delivery location, to minimize transportation time and costs.

In conjunction with one or more embodiments of the third embodiment, the instructions cause the one or more processors to modify tasks in the sequenced set of physical tasks based on available workforce, equipment, or other operational resources at each warehouse facility to maximize efficiency and minimize delays.

In conjunction with one or more embodiments of the third embodiment, the instructions cause the one or more processors to trigger task adjustments based on specific events, such as stock replenishment, equipment malfunctions, or updates to customer orders.

In conjunction with one or more embodiments of the third embodiment, the instructions cause the one or more processors to customize the sequenced set of physical tasks based on customer-specific requirements, including packaging, branding, or handling preferences provided in the inbound data packet.

In conjunction with one or more embodiments of the third embodiment, the instructions cause the one or more processors to detect task failures or delays at a warehouse facility and reallocating affected tasks to other facilities with available resources to maintain operational efficiency.

In conjunction with one or more embodiments of the third embodiment, the instructions cause the one or more processors to optimize the sequenced set of physical tasks based on energy consumption metrics, transportation distances, or equipment efficiency to reduce environmental impact of warehouse operations.

In conjunction with one or more embodiments of the third embodiment, the instructions cause the one or more processors to re-prioritize tasks in the sequenced set of physical tasks based on detected delays or bottlenecks at one or more warehouse facilities to prioritize critical tasks and meet customer deadlines.

In conjunction with one or more embodiments of the third embodiment, the instructions cause the one or more processors to optimize the sequenced set of tasks based on geographical locations of warehouse facilities relative to delivery points or supply chain nodes to reduce lead times.

In conjunction with one or more embodiments of the third embodiment, the instructions cause the one or more processors to allocate tasks in the sequenced set of physical tasks to warehouse facilities based on factors including inventory levels, workforce availability, transportation costs, or energy efficiency.

In conjunction with one or more embodiments of the third embodiment, the instructions cause the one or more processors to retrieve operational data from external systems, including Warehouse Management Systems (WMS), Supply Chain Management (SCM) systems, or Enterprise Resource Planning (ERP) systems, to inform task generation and orchestration.

In conjunction with one or more embodiments of the third embodiment, the instructions cause the one or more processors to apply forecasting data based on historical operational performance to adjust the sequenced set of physical tasks in response to predictive bottlenecks or resource constraints.

In conjunction with one or more embodiments of the third embodiment, the instructions cause the one or more processors to adjust the sequenced set of physical tasks based on operational data concerning equipment performance metrics, including machinery efficiency or downtime rates, to allocate tasks to the most capable and available equipment.

In conjunction with one or more embodiments of the third embodiment, the instructions cause the one or more processors to dynamically reallocate resources such as workforce and machinery based on real-time operational data, continuously optimizing the sequenced set of physical tasks to match available resources at each warehouse facility.

In conjunction with one or more embodiments of the third embodiment, the instructions cause the one or more processors to automatically generate and transmit notifications to customers, based order status updates or delays, based on operational data received from warehouse facilities.

In various embodiments, the present disclosure provides a system, method, and computer-readable medium that emphasize specific technical steps, real-time data integration, and automated adjustments, showing clear improvements in physical warehouse operations. In various embodiments, the system, method, and computer-readable medium demonstrate substantial technical interactions between software modules and real-world warehouse processes, such as automated light manufacturing processes, to address specific logistical issues through a specialized, technically integrated system. This integration of technical components to manage a physical environment provides a clearly described practical application. The system emphasizes specific technical components and interactions within the system that achieve warehouse management goals, ensuring that the invention is rooted in a concrete technological infrastructure to address real-world logistical problems. This system includes components, such as hardware (communication interfaces, tracking systems, and modular storage), specific processing units (predictive analytics engines, machine learning modules), and the operational interplay between components in a warehouse management environment. The specification establishes how these components work together to improve the efficiency, adaptability, and customer response capabilities of the overall system.

### BRIEF DESCRIPTION OF THE DRAWINGS

FIG. 1 illustrates an embodiment of a warehouse management system architecture.

FIG. 2 illustrates an embodiment of an order processing flow within the warehouse management system architecture depicted in FIG. 1.

FIG. 3 depicts an embodiment of an order processing flow for handling orders that require custom cable operations.

FIG. 4 illustrates a multi-level component assembly and delivery workflow, detailing steps for assembling Finished Goods #1 and #2.

FIG. 5 shows a workflow with task dependencies where certain prerequisites must be completed before proceeding to the next stage.

FIG. 6 displays an inventory structure with attributes like Unique Identifier, Type, Parent Inventory Identifier, and additional inventory attributes.

FIG. 7 is an embodiment of a computer-implemented method for controlling operations within one or more warehouse facilities.

FIG. 8 depicts an embodiment of a processor-based computing system suitable for use as a platform for executing certain routines of the presently disclosed warehouse management system.

### DESCRIPTION

A warehouse management system is described that introduces dynamic task orchestration, cloud-based scalability, AI-based inventory optimization, and the integration of light manufacturing into the workflow. These operate alone or in combination to handle complex, custom, or dynamic workflows, provide dynamic task management, provide AI-driven optimization, efficient inventory tracking, scalability, and integrates value-added services like light manufacturing. Furthermore, the warehouse management system supports custom processes or unique business needs, especially in industries requiring multi-level component assembly tracking and rigorous traceability of serialized or lot-controlled items (e.g., aerospace, automotive, and electronics sectors). The warehouse management system provide efficient inventory management, task allocation, and order fulfillment, especially when operating across multiple warehouse locations.

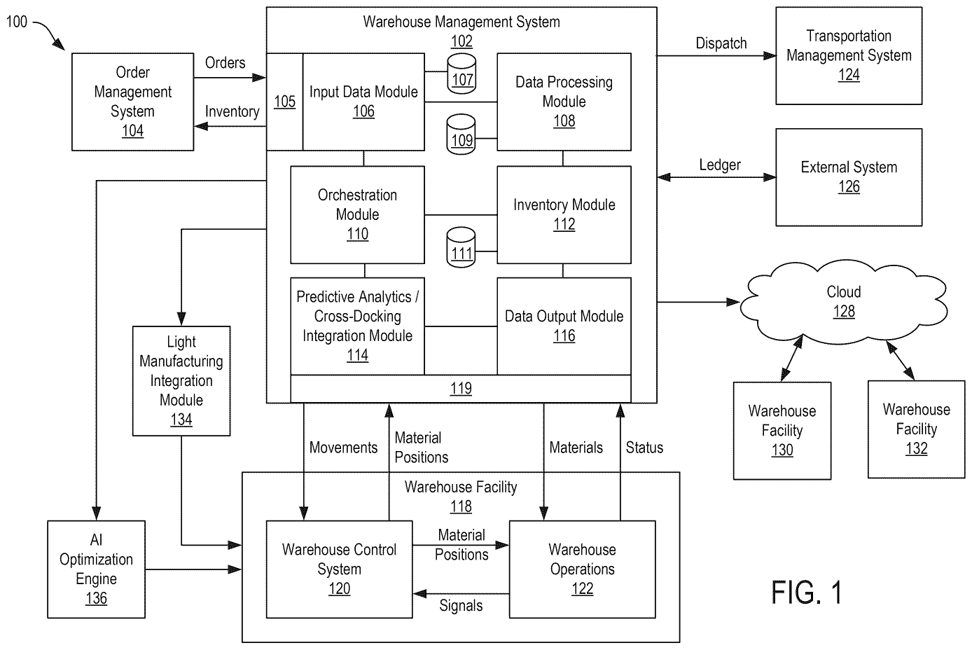

FIG. 1 illustrates an embodiment of a warehouse management system architecture 100. The warehouse management system architecture 100 includes various components and functions, all working to optimize warehouse operations and meet diverse fulfillment requirements. The various components and functions of the warehouse management system as described in the document, emphasizing dynamic task orchestration, cloud-based scalability, inventory traceability, and the integration of light manufacturing with warehouse operations.

In various embodiments, the warehouse management system architecture 100 provides a cloud-based warehouse management system 102 to dynamically generate and manage tasks based on real-time warehouse conditions, order specifics, and inventory availability. In various embodiments, the cloud-based warehouse management system 102 integrates features such as AI-driven optimization, multi-level component tracking, and support for light manufacturing processes such as cable cutting, assembly, and custom labeling. The cloud-based warehouse management system 102 provides seamless scalability across multiple warehouse locations, allowing for centralized control and improved operational efficiency. The cloud-based warehouse management system 102 adapts the picking, packing, and shipping processes based on specific customer requirements, including value-added services and tailored shipping preferences.

Several components of one embodiment of the cloud-based warehouse management system 102 may include a dynamic task orchestration module to generate tasks based on real-time conditions, inventory, and order specifications. In another embodiment, the AI-based optimization engine to analyze historical data and current warehouse conditions to optimize task prioritization, warehouse layout, and resource allocation. In another embodiment, the cloud-based warehouse management system 102 may include light manufacturing integration to allow for the fulfillment of custom orders through processes like cable cutting, stripping, and assembly. In another embodiment, the cloud-based warehouse management system 102 may include multi-level component tracking to provide traceability of serialized components throughout multiple stages of assembly and inventory management. These and other components of the cloud-based warehouse management system 102 will be described in greater detail below.

Turning back to FIG. 1, in one embodiment, the warehouse management system architecture 100 operates on a cloud infrastructure, supporting both on-premise and cloud-based operations. The warehouse management system architecture 100 coordinates warehouse activities across multiple locations by dynamically generating and managing tasks. The system includes an AI optimization engine to continuously improve warehouse operations based on real-time feedback and historical performance data.

In various embodiments, the warehouse management system 102 includes an input data module 106, a data processing module 108, an orchestration module 110, and an inventory module 112, where each of these modules can communicate with each other directly or indirectly. The data processing module 108, an orchestration module 110, and an inventory module 112 can communicate directly or indirectly with a warehouse facility 118. More specifically, the data processing module 108, orchestration module 110, and inventory module 112 can communicate directly or indirectly with a warehouse control system 120 and warehouse operations 122. In another embodiment, the warehouse management system 102 may include a predictive analytics / cross-docking integration module 114. In another embodiment, the warehouse management system 102 may include a data output module 116. These structural elements work together to create a dynamic and responsive warehouse management system 102 that can adapt to changes in real-time, ensuring optimized task flow and efficient customer order fulfillment.

In various embodiments, the input data module 106 receives and processes inbound data packets from customer orders generated by an order management system 104. The input data module 106 includes an order input interface 105 to receive the customer orders either manually or through integration with the order management system 104 or external systems 126, such as an enterprise resource planning (ERP) system-based warehouse management solution. The input data module 106 stores customer order information, including data parameters related to the customer order, specifications, product details, and quantities in a database 107.

The external system 126, such as an ERP system, may be a type of software used by organizations to manage and integrate the core functions of their business. An ERP system centralizes and automates processes across different departments such as finance, human resources, procurement, supply chain, manufacturing, and customer relationship management (CRM), allowing for streamlined operations and real-time data access. An ERP system may include various features. Centralized data integrates various business processes into a single system, providing a unified database for all departments. Automation of routine business tasks like order processing, payroll, inventory tracking, and accounting. Real-time data access provides real-time information across departments, improving decision-making and visibility into business operations. Customization, often modular, allows companies to implement only the specific functions they need. Integration with other software and external platforms, like supply chain management tools, e-commerce platforms, and financial systems, and in one embodiment, the warehouse management system 102. Common ERP providers include SAP, Oracle ERP Cloud, Microsoft Dynamics 365, Infor, and NetSuite. ERP can improve efficiency, reduce operational costs, and foster collaboration across departments.

The inbound data packets include data about physical goods stored in one or more warehouse facilities 118, 130, 132. The inbound data packets contain data parameters related to the customer order of physical goods stored in one or more warehouse facilities 118, 130, 132. The input data module 106 is capable of handling large data packets with various data parameters and ensuring smooth communication with other system modules such as the data processing module 108, orchestration module 110, inventory module 112, among others. The input data module 110 converts sales orders into formats compatible with both the warehouse management system 102 and third-party systems such as, for example, the external system 126 (e.g., ERP systems).

In various embodiments, the data processing module 108 analyzes each inbound data packet containing customer order information, data parameters related to the customer order, specifications, product details, and quantities to identify product requirements, special handling needs, and deadlines. The data processing module 108 includes a parser to extract key details from the customer order (e.g., product type, quantities, customization), processes, and sequences one or more tasks necessary for order fulfillment. A criteria engine evaluates customer order conditions and any special requirements that influence task creation.

In one embodiment, the data processing module 108 determines the optimal sequenced set of tasks for fulfilling customer orders. In one embodiment, the data processing module 108 performs order fulfillment criteria analysis and considers factors such as delivery deadlines, product specifications, and inventory levels. In one embodiment, the data processing module 108 provides data integration and is capable of connecting with external systems, like ERP and SCM systems, to gather additional insights and adjust task sequences dynamically.

More particularly, in various embodiments the data processing module 108 processes the inbound data packet for the fulfillment of the customer order. Accordingly, the data processing module 108 may extract one or more data parameters associated with the physical goods specified in the customer order. The data processing module 108 may analyze the extracted data parameters to determine a sequenced set of tasks for fulfilling the customer order based on a set of criteria. Each task allocates one or more operations to one or more of the warehouse facilities. The data processing module 108 may push the sequenced set of tasks to the one or more allocated warehouse facilities 118, 130, 132. Each warehouse facility 118, 130, 132 can communicate operational data associated with each task.

In various embodiments, the data processing module 108 may communicate data directly or indirectly with an inventory module 112. The inventory module 112 may perform a method to monitor an inventory level of physical goods of the one or more warehouse facilities 118, 130, 132, optimize storage location and pick-path efficiency, and trace serialized components through assembly, storage, and shipment stages. The inventory module 112 provides real-time inventory levels for products and components required for fulfilling the customer order. Inventory tracking sensors collect real-time data on product availability and stock levels within the warehouse facility 118, 130, 132. An inventory database 111 continuously updates and stores current stock levels. An inventory-task correlation engine matches inventory availability with customer order requirements.

In various embodiments, the data processing module 108 generates a customized sequenced set of tasks tailored to each product's specific characteristics, such as assembly, labeling, or packaging requirements, for customer orders. The data processing module 108 integrates data from external systems to dynamically adjust these tasks, ensuring accurate and efficient order fulfillment. By applying predictive analytics based on historical operational data, the data processing module 108 proactively generates or adjusts tasks to improve efficiency and prevent stock-outs.

In various embodiments, for unique or custom orders, the data processing module 108 creates a sequenced set of tasks that require different fulfillment paths, coordinating with multiple suppliers to provide a tailored and efficient customer ordering process. The data processing module 108 also generates task sequences based on customizable criteria, including urgency, delivery windows, and product perishability, allowing for dynamic adjustment to meet varying priorities.

Additionally, in various embodiments, the data processing module 108 creates task sequences based on supplier availability, considering factors such as lead times, delivery routes, and supplier performance data, optimizing supplier selection for timely and cost-effective order fulfillment.

In various embodiments, the orchestration module 110 includes an orchestration engine to adjust and orchestrate the task sequence dynamically based on changes in order specifications, inventory levels, and real-time warehouse conditions. A task adjustment module to modify task sequences when there are changes in order details or inventory availability. An orchestration controller ensures task execution is synchronized with real-time conditions, optimizing the workflow. A task prioritization engine prioritizes tasks based on urgency, stock availability, and warehouse conditions. A real-time decision engine continuously evaluates and optimizes task sequencing and orchestration based on live data. A data integration module integrates inventory data stored in the inventory database 111, operational monitoring, and order processing systems. Optimization algorithms evaluate real-time data to dynamically optimize the task flow and ensure timely order fulfillment.

In various embodiments, the orchestration module 110 manages and optimizes task execution across warehouse facilities 118, 130, 132. In one embodiment, the orchestration module 110 can communicate data directly or indirectly with the data processing module 108 to orchestrate the sequenced set of tasks based on the operational data received from the one more warehouse facility 118, 130, 132 to fulfill the customer order. The orchestration module 110 provides resource allocation by assigning tasks based on proximity to delivery location, warehouse capabilities, or availability of workforce and equipment. The orchestration module 110 dynamically re-prioritizes tasks in response to real-time conditions, such as delays, bottlenecks, or equipment issues. The orchestration module 110 also provides environmental optimization by minimizing the environmental footprint by considering transportation distances, energy consumption, and equipment efficiency.

The orchestration module 110 generates and manages tasks in real-time based on various factors such as order details, inventory availability, and warehouse conditions. Unlike traditional warehouse management systems, which rely on predefined workflows, the dynamic task orchestration module 110 can adjust task sequences dynamically, allowing for greater flexibility and responsiveness in handling complex workflows. For example, if a specific item is out of stock, the dynamic task orchestration module 110 can prioritize other tasks while awaiting inventory replenishment, to minimize downtime. The system tracks task progress using various states, including “Task Available,” “Task Assigned,” and “Task Complete,” ensuring efficient task execution.

The implementation of the warehouse management system 102 provides several benefits including increased operational efficiency through dynamic task orchestration and automation of complex workflows. Unlike traditional warehouse management systems, which rely on predefined, rigid workflows that cannot adapt to changing warehouse conditions or customized orders, the orchestration module 110 provides an orchestration process that adjusts task sequences dynamically independent of predefined workflows, allowing for greater flexibility and responsiveness in handling complex workflows in handling orders. The dynamic task orchestration by the orchestration module 110 allows tasks to be generated and adjusted in real-time based on the specific requirements of each order and the current state of the warehouse facility 118, 130, 132. For example, when an order is received by the input date module 106, the orchestration module 110 evaluates the inventory, checks for custom requirements (e.g., cable cutting or assembly), and creates tasks dynamically to meet those needs. This task management system is flexible enough to handle unexpected changes, such as inventory shortages or last-minute customer changes, and allows the system to reconfigure workflows on the fly.

In various embodiments, the orchestration module 110 adjusts the sequenced set of tasks based on operational data from warehouse facilities 118, 130, 132. The orchestration module 110 prioritizes tasks using criteria like delivery deadlines, product perishability, or order value to enhance fulfillment efficiency. Tasks are allocated to specific warehouse facilities 118, 130, 1332 based on their proximity to delivery locations, minimizing transportation time and costs.

In various embodiments, the orchestration module 110 modifies tasks according to the availability of workforce, equipment, or other resources to optimize capacity and reduce delays. The orchestration module 110 can adjust or trigger tasks based on events such as stock replenishment, equipment malfunctions, or updates to customer orders. Customization of task sequences is possible based on customer-specific preferences, including special packaging or unique handling instructions.

If task failures or delays occur, in various embodiments, the orchestration module 110 reallocates tasks to other facilities with available capacity to maintain efficiency. The orchestration module 110 optimizes task sequences based on energy consumption, transportation distances, or equipment efficiency to reduce the environmental footprint. The module re-prioritizes tasks when delays or bottlenecks are detected to ensure critical tasks meet customer deadlines.

In various embodiments, task sequences are optimized based on the geographical location of warehouse facilities 118, 130, 132 relative to delivery destinations, minimizing transportation distances and lead times. Tasks are allocated based on criteria like inventory levels, workforce availability, transportation costs, and energy efficiency for comprehensive optimization.

In various embodiments, the orchestration module 110 retrieves data from external systems 126, such as Warehouse Management Systems, Supply Chain Management systems, or Enterprise Resource Planning systems, to inform task orchestration. The orchestration module 110 uses forecasting data to adjust tasks in anticipation of bottlenecks or resource constraints. Task sequences are adjusted based on equipment efficiency metrics to assign tasks to the most capable equipment.

In various embodiments, the orchestration module 110 dynamically reallocates resources, including workforce and machinery, based on real-time data, continuously optimizing task sequences to match available resources at each warehouse facility.

Additionally, in various embodiments, the orchestration module 110 provides dynamic task orchestration. The orchestration module 110 orchestrates tasks dynamically, adapting to real-time conditions and the specific requirements of each order, unlike traditional systems that rely on fixed workflows. When a customer order is created in the order management system 104, it is automatically transferred to the data input module 106. The warehouse management system 102 then transforms the sales order into a warehouse order, translating any custom requirements into specific warehouse tasks.

In various embodiments, the warehouse management system 102 generates a sequenced set of tasks based on the order's details, such as picking items, packing, or performing light manufacturing tasks like cable cutting and labeling. As warehouse conditions change, such as inventory availability or workforce capacity, the orchestration module 110 adjusts tasks in real-time, rerouting or prioritizing operations to ensure timely order completion.

For example, if an order requires custom cable cutting, the data processing module 108 generates a cutting task and integrates it into the overall pick-pack-ship workflow. If there's an inventory shortage, the orchestration module 110 automatically adjusts the process to resolve the issue efficiently.

In various aspects, the inventory module 112 monitors stock levels, manages pick-path optimization, and ensures effective storage. In monitoring inventory levels, the inventory module 112 tracks stock levels in real-time and adjusts task sequences accordingly. To optimize efficiency, the inventory module 112, adjusts storage locations and picking paths to streamline order processing. The inventory module 112 manages serialized components, tracking them through storage, assembly, and shipping to provide traceability.

In various embodiments, the data processing module 108 may communicate data directly or indirectly with the inventory module 112. The inventory module 112 may perform a method to monitor an inventory level of physical goods of the one or more warehouse facilities, optimize storage location and pick-path efficiency, and trace serialized components through assembly, storage, and shipment stages. In various embodiments, the inventory module 112 adjusts the sequenced set of tasks based on real-time inventory levels at the one or more warehouse facilities to ensure that tasks are adapted to current stock availability.

In various embodiments, the inventory module 112 is responsible for several critical warehouse functions, including stock level monitoring, pick-path optimization, and storage efficiency. By tracking stock levels in real-time, the inventory module 112 can dynamically adjust task sequences to maintain efficient operations. This includes optimizing storage locations and pick paths, streamlining the order fulfillment process. Additionally, the inventory module 112 manages serialized components, ensuring complete traceability through storage, assembly, and shipping. The inventory module 112 provides enhanced flexibility for custom orders and light manufacturing while strengthening inventory management and traceability.

In various embodiments, the warehouse management system 102 supports the assembly of components into finished goods with full traceability, critical for industries demanding high accountability. This traceability feature enables effective management of complex inventory requirements like serialized and lot-controlled items, ensuring compliance with regulatory and quality standards. By managing inventory exceptions (e.g., damaged goods or backorders), the inventory module 112 minimizes delays and enhances stock accuracy, reducing instances of stockouts, overstocking, and inventory shrinkage.

Additionally, in various embodiments, the inventory module 112 tracks multi-level assembly of components, linking them to finished goods with unique identifiers and attributes like part number and quantity. Multi-level component tracking provides detailed tracking of serialized components throughout the entire assembly process in the warehouse operations 122. Each component is assigned a unique identifier and tracked through multiple stages, including picking, assembly, and shipping. The warehouse management system 102 supports multi-stage assembly, ensuring that all components are accurately tracked and linked to their final products. For instance, if a product consists of several sub-components (e.g., wires, fasteners), the system tracks each component's status, location, and quantity through the assembly stages. The tracking system is particularly useful for industries with stringent traceability requirements, such as automotive or aerospace.

Inventory types are defined within the warehouse management system 102: Actual (ACT) represents sellable inventory, Work in Progress (WIP) denotes partially transformed items, Component (COMP) is used for parts integrated into other items, and Ship Complete (SHC) indicates inventory that has been shipped. For instance, finished products are sent to storage if they are completed before their scheduled ship date. The inventory module 112 tracks each inventory component down to the serial or lot number, which is advantageous for industries like automotive and aerospace manufacturing.

Moreover, in various embodiments, the warehouse management system 102 offers partial assembly options when full inventory is unavailable, allowing flexibility in deciding whether to ship partial orders or await complete stock. In cases where items are unavailable at the primary warehouse 118, inventory can be sourced from alternate warehouse facilities 130, 132. The inventory module 112 assigns each item in the inventory a unique identifier and links to its assembled product via a parent inventory identifier.

In various embodiments, AI-driven features of the inventory module 112 will further enhance efficiency by analyzing historical order patterns, seasonal trends, and current inventory levels to optimize inventory placement, reduce picking times, and prioritize tasks based on urgency and warehouse conditions. This AI integration is projected to decrease labor costs, expedite order processing, and improve overall warehouse operations. The inventory module 112 also includes a cycle count feature, providing real-time monitoring of inventory levels, identifying discrepancies, and enabling corrective actions.

In various embodiments, the data output module 116 oversees customer communication by providing timely order updates and notifying customers of any delays. It generates and sends real-time status updates to customers based on order progress and any detected issues. In one embodiment, the data output module 116 interacts with the orchestration module 110 to automatically create and send notifications about order status or delays, utilizing data from the warehouse facilities 118, 130, and 132.

In addition, the predictive analytics and cross-docking integration module 114 uses historical data to improve task planning and reduce storage costs. This module applies predictive models to forecast and adjust tasks proactively, to help prevent bottlenecks. Cross-docking further supports this goal by enabling the direct transfer of inbound goods to outbound shipments, minimizing handling time and associated costs.

The warehouse management system 102 interfaces with a warehouse control system 120 via a user interface/dashboard 119 to coordinate a range of warehouse operations 122, including both single and multi-level component assembly with detailed traceability for serialized or lot-controlled items. A real-time monitoring dashboard displays key metrics such as task status, inventory levels, and operational bottlenecks. An alert system notifies users of any critical changes or disruptions in the task sequence or inventory status.

The warehouse control system 120 monitors and adjusts each stage of assembly, from components to finished goods, supporting industries that require strict accountability, such as aerospace and automotive, by ensuring regulatory compliance and quality control. The warehouse control system 120 includes a warehouse operational condition monitoring system to monitor and adjust for real-time conditions in the warehouse 118, such as equipment status, workforce availability, and processing capacity. The warehouse control system 120 includes a warehouse sensor network to monitor factors such as equipment functionality, worker availability, and processing load. An operational data hub collects and analyzes warehouse conditions in real-time to optimize task allocation.

The warehouse control system 120 tracks material positions throughout warehouse operations 122. Various sensors, such as IoT sensors, barcode scanners, and RFID tags/readers, monitor material locations, component statuses, and inventory levels in real-time, providing data back to the warehouse control system 120 for precise material tracking. For instance, RFID readers and barcode scanners help manage inventory and item positioning within the warehouse facility 118 or other warehouse facilities 130, 132.

Furthermore, the warehouse control system 120 manages multi-level assembly tracking, capturing the entire assembly process for each component, especially serialized or lot-controlled items. The warehouse control system 120 logs each step of the assembly process in the warehouse operations 122, ensuring comprehensive traceability of all materials used. Once a product is fully assembled, the warehouse control system 120 records the finished product's serial number and its associated parts. For example, if parts A and B are assembled into component C, and component C is further incorporated with other parts to complete the final product, the WCS records each assembly stage. This feature is essential in industries like aerospace and automotive, where traceability and regulatory compliance are critical.

The warehouse management system 102 integrates light manufacturing processes into the warehouse operations 122 workflows via the light manufacturing integration module 134, enabling the execution of value-added services such as cable cutting, stripping, printing, and assembly. These processes are dynamically orchestrated alongside standard warehouse tasks, allowing for seamless custom order fulfillment. For example, if a customer orders custom-cut cables, the system generates tasks for cutting, labeling, and packaging the cables according to the customer's specifications.

In some configurations, the light manufacturing integration module 134 adds value-added services, such as product customization and light manufacturing, directly into the warehouse operations 122 workflow. By automating these tasks—such as cable cutting, wire twisting, labeling, and printing—the system reduces manual processes, decreases errors, and increases throughput, leading to labor cost savings.

The integration of light manufacturing capabilities enables services like cable cutting to custom lengths, custom packaging, and wire twisting, streamlining processes that would otherwise require separate systems. The warehouse management system 102 handles orders requiring specific cable lengths, printed labels, and twisted wires to meet custom specifications. It creates tasks for these value-added services, incorporating them into the overall warehouse operations 122 workflow. Once customizations are complete, the warehouse management system 102 directs the warehouse team or automation systems to package and label products according to customer specifications. For example, if a customer requests a specific cable length with custom labeling, the system creates a cutting task, assigns labeling instructions to machines, and moves the finished product to packaging for shipping.

In various embodiments, warehouse operations 122 include custom labeling and shipping integration. This allows for the customization of shipping documents, labels, and manifests based on customer requirements. The warehouse management system 102 integrates with external shipping services, such as the transportation management system 124, ensuring customers receive accurate shipping confirmations and advanced shipping notifications (ASNs). The transportation management system 124 also manages dock door assignments and shipping schedules, optimizing operations based on real-time conditions.

Through such seamless integration, the warehouse management system 102 eliminates the need for external systems or manual intervention, enhancing efficiency and responsiveness for customized orders.

The AI optimization engine 136 also supports advanced data analytics with cloud integration 128, creating a comprehensive platform for improved forecasting, decision-making, and proactive warehouse optimization. This engine provides real-time insights into inventory levels, order statuses, and overall warehouse operations, enabling quick, informed decisions and enhancing operational transparency. It prioritizes tasks based on factors such as order urgency, available resources, and warehouse conditions, ultimately lowering labor costs, speeding up order processing, and optimizing efficiency across warehouse operations.

Additionally, the AI-powered inventory optimization component in warehouse management system 102 leverages collected data to optimize tasks such as slotting inventory, establishing efficient picking paths, and managing order prioritization. The system gathers data on inventory levels, order patterns, warehouse layout, and operational metrics, which the AI then processes to determine ideal product placement (slotting) and recommend optimized picking routes for staff or robotic systems. Real-time AI-driven adjustments to scheduling and inventory movement ensure peak operational efficiency. For instance, if certain products are frequently ordered together, the AI will suggest positioning them close to each other, reducing picking and packing time.

In various embodiments, the warehouse management system's 102 cloud-based scalability feature enables centralized control and coordination across multiple warehouses, providing a global view of inventory, tasks, and manufacturing processes. By operating through a cloud infrastructure, such as AWS, Microsoft Azure, or Google Cloud, the system offers seamless scaling across facilities 118, 130, and 132. Cloud-based centralization allows for inventory balancing, reducing delays and enhancing communication between warehouses. With cross-warehouse optimization, inventory transfers are managed efficiently to maintain balanced stock levels, preventing overstocking or stockouts. This centralized control facilitates real-time stock adjustments across locations, ensuring smooth and prompt fulfillment. For example, if one facility (e.g., warehouse 118) is low on stock for a specific item, the warehouse management system can instantly arrange for inventory transfers from facilities 130 or 132 to prevent order delays.

In various embodiments, within the cloud-based environment, the warehouse management system 102 coordinates with the orchestration module 110 to dynamically create and manage tasks based on real-time conditions, order details, and available inventory. The inventory module 112 provides detailed traceability for serialized components, multi-stage assembly processes, and real-time updates. The light manufacturing module 134 is seamlessly integrated into warehouse operations 122, enabling custom order fulfillment options such as cable cutting, stripping, labeling, and assembly as part of the workflow. The AI optimization engine 136, powered by advanced machine learning algorithms, optimizes warehouse layouts, task prioritization, and inventory placement using both historical data and real-time insights, delivering a streamlined, scalable, and globally coordinated warehouse management solution.

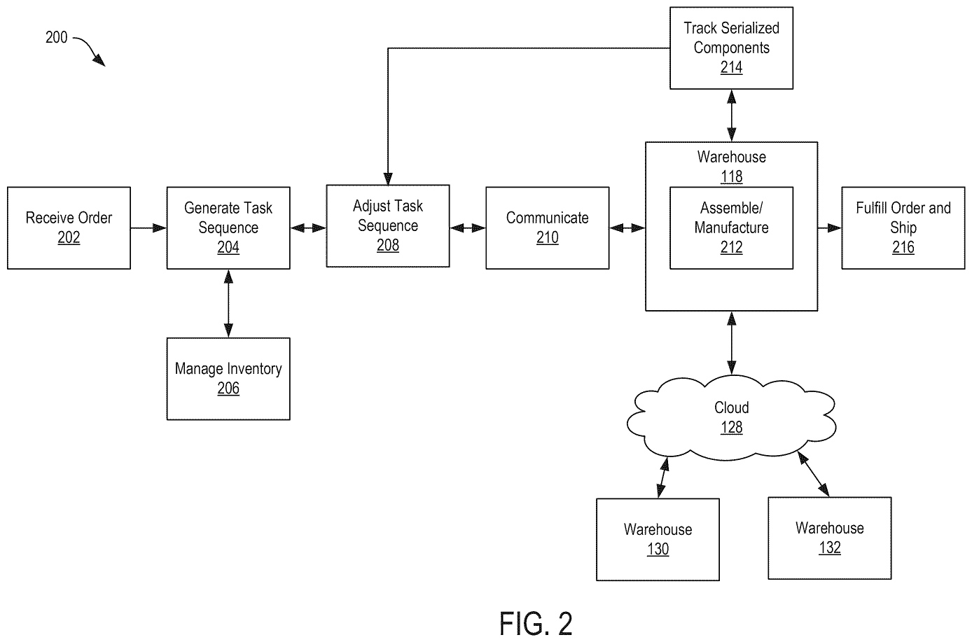

FIG. 2 illustrates an embodiment of an order processing flow 200 within the warehouse management system architecture 100 depicted in FIG. 1. As shown in FIG. 2 and FIG. 1, the input data module 106 receives 202 an order from the order management system 104. In response, the data processing module 108 generates 204 a sequenced set of tasks tailored to current inventory levels and operational conditions.

In various embodiments, the inventory module 112 actively manages 206 stock levels, tracking serialized components with RFID readers and inventory management systems to ensure real-time updates. The orchestration module 110, connected 210 to the warehouse facility 118, dynamically adjusts 208 task priorities and sequences by processing feedback from IoT sensors and worker performance metrics. This flexibility allows for immediate responses to changes in the state of the assembly or manufacturing processes 212 within the warehouse facility 118, as well as other cloud-connected warehouse facilities 130, 132. The system coordinates multi-level assembly tasks and light manufacturing processes, adjusting based on specific customer order requirements and tracking 214 serialized components through each stage of assembly or manufacturing.

Real-time feedback loops inform the orchestration module 110, which makes on-the-fly adjustments 204 to the sequenced task set, ensuring optimal workflow. Leveraging the cloud computing infrastructure 128, the system provides scalable management across multiple warehouse facilities 130, 132, with synchronized task and inventory data available in real-time across all locations. Once assembly and manufacturing processes 212 are complete, the system coordinates fulfillment and shipping 216, managing packing, shipping, and delivery preferences through an integrated shipping module.

Together, this system integrates both hardware and software components to create a scalable, efficient, and responsive warehouse management system 102, enabling seamless operations and real-time adaptability across multiple facilities.

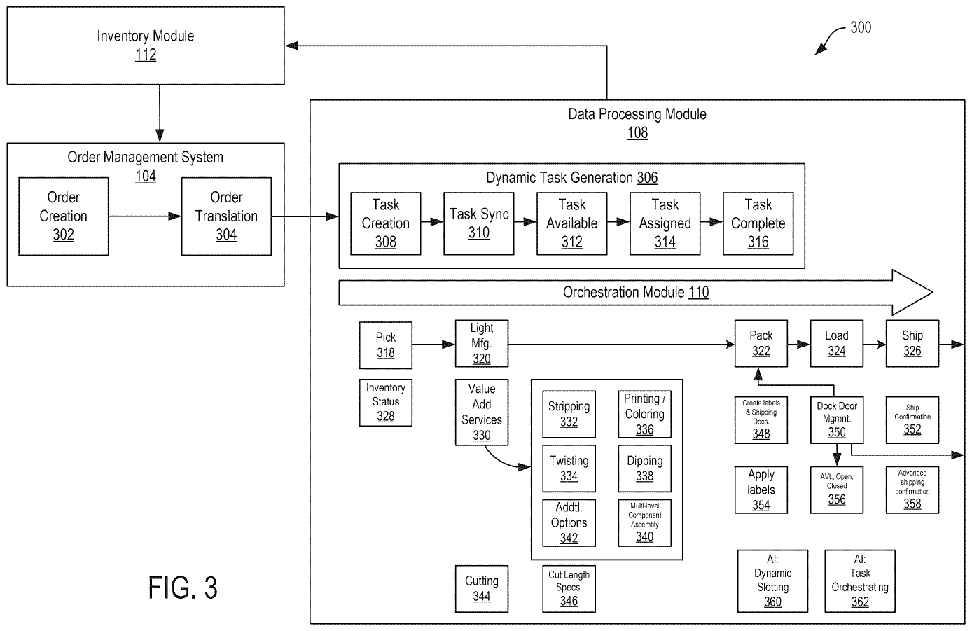

FIG. 3 depicts an embodiment of an order processing flow 300 for handling orders that may require custom light manufacturing operations. Referring to FIG. 3 in conjunction with FIG. 1, the warehouse management system 102 orchestrates tasks dynamically based on real-time conditions and order-specific requirements, departing from the fixed workflows of traditional systems. When a customer order is created 302 within the order management system 104 (e.g., sales system), it is automatically forwarded to the warehouse management system 102, which translates 304 the sales order into a warehouse order and converts any custom requirements into specific warehouse tasks.

In various embodiments, the inventory module 112 offers real-time stock updates and tracks serialized components needed to fulfill the order, managing inventory through various I/O devices such as RFID scanners, IoT sensors, and mobile handhelds. These devices capture real-time data on inventory status, item locations, environmental conditions, and user commands.

The data processing module 108 dynamically generates 306 a sequenced set of tasks according to order details, such as item picking, packing, or light manufacturing tasks (e.g., cable cutting, labeling). Task generation 306 includes phases for task creation 308, synchronization 310, availability 312, assignment 314, and completion 316, including picking 318 required components and monitoring inventory status 328.

As warehouse conditions shift (e.g., inventory availability, workforce levels), the orchestration module 110 adjusts tasks dynamically, rerouting or prioritizing them to ensure timely order completion. For orders involving custom cable cutting, the data processing module 108 generates a cutting task 344, which is seamlessly integrated into the overall workflow. In case of inventory shortages, the orchestration module 110 adapts the process to resolve the issue.

The system also supports integrated light manufacturing 320 within the warehouse management process, eliminating the need for separate systems to handle tasks like cutting 344, stripping 332, twisting 334, labeling 348, or assembling. When customization is required (e.g., specific cable lengths or labeling), tasks for these value-added services 330 are generated and incorporated into the workflow. Automated machines may carry out customization tasks 330, including cable cutting 344, wire stripping 332, twisting 334, printing or coloring 336, dipping 338, multi-level component assembly 340, and other modifications as per customer requirements based on instructions from the orchestration module 110. Once customizations are complete, the system directs packaging 322 and labeling 354 according to customer preferences, applying labels and readying the product for shipment.

For example, during the order translation 304, the order management system 104 may parse an inbound data packet corresponding to the created order to extract parameters that dictate the need for light manufacturing. The extracted parameters may include customization specifications such as cable length, wire gauge, insulation type, labeling requirements, coating preferences, and/or assembly configurations. The customization specifications may be embedded in fields like “special instructions” or “product customization codes.” For example, an order for a custom wiring harness might specify a specific length of cable requiring stripping and twisting. As another example, an order for a labeled electronic component might require printing and multi-level assembly. The order management system 104 may employ a rule-based parser that matches these parameters against a predefined task library, flagging tasks like cutting 344, stripping 332, twisting 334, printing or coloring 336, dipping 338, or multi-level component assembly 340 based on the presence of specific automated light manufacturing task triggers.

The data processing module 108 may include automated light manufacturing tasks in the set of sequenced tasks based on parameters derived from the customer order by the order management system 104. The data processing module 108 may analyze order details, incorporating factors such as material specifications, customization requirements, and real-time resource availability. The data processing module 108 may employ algorithmic processes, such as heuristic optimization and/or machine learning models, to break down complex orders into discrete, executable steps. For example, for a custom cable order, the data processing module 10 may identify dependencies (e.g., ensuring wire stripping precedes twisting) then assign tasks to available automated machines while factoring in constraints (e.g., machine calibration status, energy efficiency metrics, scheduled maintenance, machine capabilities). The data processing module 108 may utilize predictive analytics to forecast potential bottlenecks, generating alternative sequences that can be swapped in real-time by the orchestration module 110 based on detected operational changes, thereby enhancing the system's adaptability to fluctuating demands.

As part of the dynamic task generation 306 process, the data processing module 108 may receive the translated order from the order management system 104, including the specific automated light manufacturing tasks, such as stripping 332, twisting 334, or assembly 340. The data processing module 108 module may initiate dynamic task generation 306 by first validating the task list against current warehouse resources and operational data, ensuring compatibility with available automated machines. The data processing module 108 may proceed with task creation 308 by initiating task objects in memory, each linked to a specific operation (e.g., cutting 344) and associated with resource allocation constraints like machine availability and material stock levels, derived from sensor feedback and inventory databases.

For task synchronization 310, the data processing module 108 may construct a dependency graph, such as a directed acyclic graph (DAG), mapping prerequisites between tasks (e.g., stripping 332 must precede twisting 334). This graph may be populated with edge weights representing estimated execution times, calculated via regression models trained on historical data, ensuring that the sequence respects inter-task dependencies across multiple orders. The data processing module 108 may determine task availability 312 by checking real-time data inputs (e.g., RFID senser data for detecting material availability material, automated light manufacturing machines data outputs for detecting machine availability) to confirm resource readiness, flagging tasks as executable once prerequisites are met. Based on task availability, the data processing module 108 may assign 314 automated light manufacturing tasks to corresponding warehouses resources (e.g., light manufacturing machines) as part of a sequenced set of physical tasks for order fulfillment.

In some examples, the data processing module 108 may integrate contextual data, such as order urgency, material availability, and customer service level agreement (SLA) requirements, to determine the scope and timing of light manufacturing tasks within the sequenced set of physical tasks. For example, an order parameter indicating a “high-priority” status with an expedited deadline may cause the data processing module 108 to prioritize the assignment of automated light manufacturing resources. The data processing module 108 process may implement a decision tree algorithm that evaluates parameter combinations, assigning weights to each task based on complexity and resource impact. Thus, the data processing module 108 may manage and prioritize sequenced task generation for multiple (e.g., hundreds, thousands) of current concurrent orders to ensure that the order fulfillment process is optimized.

The data processing module 108 can sequence the automated light manufacturing tasks by leveraging a multi-layered algorithmic approach that begins with input aggregation from diverse sources. Inputs may include order parameters extracted from the inbound data packet for the order, such as product specifications, quantities, and customization details, alongside real-time warehouse data like machine availability and inventory levels. The data processing module 108 may employ a dependency graph algorithm to map inter-task relationships, ensuring that prerequisite tasks, such as material preparation, precede dependent ones like assembly. The graph may be constructed using adjacency matrices where edges represent temporal or resource dependencies, allowing for efficient topological sorting to generate an initial linear sequence.

To handle multiple orders, the data processing module 108 may utilize a batching heuristic that groups similar tasks across orders based on shared inputs, such as common material types or machine compatibility. Inputs for the batching heuristic can include similarity metrics computed via cosine similarity on vectorized order features (e.g., wire gauge, length requirements), enabling the data processing module 108 to merge sequences and reduce setup times. For example, if two orders require cable cutting of similar lengths, the algorithm can prioritize batching to minimize tool changes, optimizing the overall sequence using a genetic algorithm that evolves candidate batches through selection, crossover, and mutation operations to maximize throughput while minimizing energy consumption.

The data processing module 108 may predict downtime and material availability during dynamic task generation utilizing inputs like historical machine logs and sensor histories, processed through time-series forecasting models like ARIMA (AutoRegressive Integrated Moving Average). The data processing module 108 can analyze patterns to estimate future downtime probabilities. Material availability may be predicted by the data processing module 108 via supply chain data and consumption rates, employing exponential smoothing with previous forecast to adjust inventory projections, ensuring task sequences avoid scheduling on potentially unavailable resources.

The orchestration module 110 is operable to cause the light manufacturing machines to automatically execute light manufacturing tasks according to the sequenced set of tasks generated by the data processing module 108.

For automated cutting tasks 344, the orchestration module 110 may control warehouse resources such as automated precision CNC (Computer Numerical Control) cutters or laser cutting machines, which may be equipped with servo motors and optical sensors for accurate length measurements. The orchestration module 110 may transmit a signal with sequenced instructions via a programmable logic controller (PLC) interface, specifying parameters such as cut length, speed, and blade angle based on the extracted order data. The orchestration module 110 may detect operational changes associated with warehouse resources used for cutting tasks. For example, the orchestration module 110 may receive signals with operational data from vibration sensors or thermal imagers monitoring blade wear, trigger dynamic reallocation—such as switching to a backup cutter if overheating is sensed—to prevent downtime. This dynamic control by the orchestration module 110 can ensure cuts are efficiently executed while minimizing material waste and integrating seamlessly with subsequent tasks like stripping.

For automated stripping tasks 332, the orchestration module 110 may control warehouse resources such as automated wire stripping machines featuring adjustable pneumatic clamps and rotary blades, controlled via stepper motors for precise insulation removal. The orchestration module 110 may detect operational changes associated with warehouse resources used for stripping tasks. For example, the orchestration module 110 may receive signals with operational data including sensor feedback from force transducers to detect variations in wire diameter or insulation thickness, and data sensed by proximity sensors that is indicative of a machine malfunction (e.g., a jam). The orchestration module 110 may reallocate stripping tasks to an alternative machine or pause the sequence, rerouting resources like compressed air supply to maintain efficiency. This dynamic control supports high-speed operations while minimizing material waste and bottlenecks due to machine malfunctions.

For automated twisting tasks 334, the orchestration module 110 may control warehouse resources such as automated twisting machines (e.g. twisting machines with dual-spindle motors and tension controllers). The orchestration module 110 may detect operational changes associated with warehouse resources used for twisting tasks. For example, the orchestration module 110 may receive signals with operational data from sensors (e.g., Hall-effect sensors) that monitor rotation speed and twist uniformity, providing data that the orchestration module 110 may use to fine-tune motor RPM and tension in response to material variances, such as wire flexibility detected via strain gauges. The orchestration module 110 may dynamically reallocate task resources based on detected operational changes (e.g., if sensors detect slippage—perhaps due to humidity changes sensed by environmental monitors—shifting the task to a climate-controlled unit or adjusting the sequence to prioritize less sensitive operations), thus preventing defects in multi-level assemblies.

For automated printing or coloring tasks 336, the orchestration module 110 may control warehouse resources such as automated inkjet or laser marking machines equipped with high-resolution print heads and color sensors for accurate application of labels or dyes. Based on the generated tasks, the orchestration module 110 may issue instructions with precise positioning and color calibration to the warehouse resources for printing and coloring. Instructions may be adjusted in real-time by the orchestration module 110 based on feedback from optical character recognition (OCR) cameras that verify print quality. The orchestration module 110 may dynamically reallocate printing resource tasks based on detecting operational changes, such as ink level depletion detected by capacitive sensors (e.g., switching to a secondary print head or rerouting the task to another station).

For automated dipping tasks 338, the orchestration module 110 may control warehouse resources such as automated immersion dipping machines with programmable robotic arms and level sensors to regulate chemical baths. Based on the generated tasks, the orchestration module 110 may issue instructions specifying dip duration and depth. The orchestration module 110 may monitor operational data such as viscosity via flow meters and temperature via thermocouples to adjust immersion speed in real-time. The orchestration module 110 may communicate with sensors for detecting contaminants (e.g., pH sensors) and other operational issues. The orchestration module 110 may dynamically reallocate resources by initiating a bath refresh cycle or diverting tasks to a backup dipper—preventing quality issues in protective coatings for components destined for assembly stages.

For automated multi-level component assembly tasks 340, the orchestration module 110 may control warehouse resources such as collaborative robotic arms (cobots) or automated guided vehicles (AGVs) fitted with grippers and 3D vision cameras for precise part placement. The orchestration module 110 can process sequenced instructions to layer components, monitoring joint integrity via sensors (e.g., ultrasonic sensors) and adjusting grip force in real-time based on material feedback. The orchestration module 110 may dynamically reallocate resources for assembly tasks based on detecting operational changes, such as part shortages detected by inventory RFID readers.

Additional automated light manufacturing operations 342, such as crimping or soldering, may be controlled by the orchestration module 110 through multi-tool robotic stations equipped with interchangeable end-effectors and vision systems for alignment. The orchestration module 110 may sequence these operations based on dependency graphs from task generation 306, using force-torque sensors to detect anomalies like misalignment and reallocating to alternative tools if needed. Environmental sensors (e.g., humidity detectors) provide data to the orchestration module 110 for real-time adjustments, ensuring robust connections in custom assemblies while optimizing energy use by powering down idle effectors.

Various hardware sensors may facilitate detection of operational changes across light manufacturing tasks, including proximity sensors for material presence, vibration analyzers for machine health, and thermal cameras for overheating. These sensors may feed operational data to the orchestration module 110, enabling predictive maintenance and reallocation. For example, if a current sensor detects overload in a twisting motor, the orchestration module 110 may reallocate the task to a redundant unit, adjusting the overall task sequence to minimize delays while ensuring serialized tracking remains uninterrupted through integrated barcode scanners at each station.

The orchestration module 110 can serve to automatically control the light manufacturing 320 operations by interfacing directly with the hardware and machinery involved. Upon receiving operational data feedback from sensors embedded in the manufacturing equipment, the orchestration module 110 can evaluate the current state of each task against the sequenced set of physical tasks generated during dynamic task generation 306 across several (e.g., hundreds, thousands) of orders. This control is achieved through a combination of real-time decision algorithms and communication protocols that allow the orchestration module 110 to send precise instructions to the machines. For instance, the orchestration module 110 can adjust parameters like speed, torque, or cutting depth based on detected variances, ensuring seamless integration with upstream processes like picking 318 and downstream activities such as packaging 322. This automated oversight reduces latency in task execution, with the orchestration module 110 continuously polling sensor data to preemptively modify operations and maintain optimal throughput.

In some examples, the orchestration module 110 is involved in the dynamic task generation process, serving as a real-time arbiter that validates and adjusts the sequences proposed by the data processing module 108. During task creation 308, the orchestration module 110 may pre-allocate resources based on its current utilization data, ensuring that initial task assignments align with available machine capacities. In task synchronization 310, the orchestration module 110 may resolve conflicts by negotiating dependencies with the data processing module 108, using a consensus protocol to lock resources until prerequisites are met. As tasks reach availability 312, the orchestration module 110 may activate communication channels to the warehouse control system 120, triggering machine startup sequences. During task assignment 314, the orchestration module 110 may dispatch detailed execution instructions, and upon task completion 316, the orchestration module 110 may update the operational data pool, feeding back into the next cycle of generation and adjustment for continuous optimization.

Automated task execution in light manufacturing machinery may be monitored through a multi-sensor fusion approach, where the orchestration module 110 aggregates data from embedded devices like encoders for position tracking, accelerometers for motion analysis, and vision systems for quality inspection. For each light manufacturing machine, a dedicated monitoring subroutine may run at high frequency (e.g., 100 Hz), computing key performance indicators (KPIs) such as cycle time variance using statistical process control (SPC) charts. Anomalies may be flagged if metrics exceed control limits.

The orchestration module 110 may process monitored inputs using anomaly detection algorithms, such as isolation forests or autoencoders, to identify deviations from normal operation. For example, an autoencoder may reconstruct input vectors and flag high reconstruction errors as potential issues, with thresholds set via statistical analysis of baseline data. This allows detection of subtle changes, like gradual tool dulling in cutting machines inferred from increased power draw, or alignment drifts in assembly arms from cumulative gyroscopic errors.

The orchestration module 110 may trigger dynamical reallocation of task execution by modeling the system as a Markov decision process (MDP) to select optimal actions. States may be represented by current machine statuses, actions may include task reassignment and/or parameter tweaks, and rewards penalize delays while favoring efficiency.

Dynamic task reallocation among automated light manufacturing tasks provides significant technological advantages, including enhanced fault tolerance through redundant pathways to maintain uptime and expedite order fulfillment. This reallocation may also improve precision in serialized component handling, reducing defect rates through proactive adjustments that ensure consistent quality across variable conditions.

Additionally, the warehouse management system 102 includes dock door management 350, coordinating inbound and outbound trailers and integrating with shipping 326 services to support customer-specified or optimized shipping options. Real-time vehicle location (AVL), automated dock door operations 356, and shipping confirmations 358 are also supported.

The system allows for comprehensive tracking of multi-level component assemblies 340, ensuring detailed monitoring of each assembled part from warehouse facility to final assembly. It tracks individual components, including serial and lot numbers, as they progress through the assembly process. For example, in the assembly of parts A and B into component C, the system logs all component data, enabling easy traceability for quality control or recalls if a component proves defective.

Operating on a cloud-based architecture, the warehouse management system 102 centrally controls multiple facilities 118, 130, 132 with real-time updates and scalability across global operations. The cloud platform facilitates inter-warehouse inventory transfers to balance stock and meet order demands efficiently. This centralized control improves visibility and coordination, as illustrated when a facility 118 running low on a product triggers an automated stock transfer from another facility 130, 132.

The system also includes an AI-driven inventory optimization engine that enhances warehouse operations by dynamically slotting 360 inventory, orchestrating tasks 362, optimizing picking paths, and prioritizing orders. Through data collection and analysis of inventory levels, past order trends, warehouse layouts, and operational performance, the AI component maximizes efficiency in product placement (slotting), recommends optimized picking paths, and schedules tasks in real time for peak warehouse performance. For instance, historical order data may suggest placing frequently co-ordered items closer together, reducing picking times.

The dynamic slotting 360 may be performed using various machine learning models to intelligently position inventory items within the warehouse. Machine learning models for dynamic slotting 360 may include reinforcement learning (RL) models, such as Deep Q-Networks (DQN), which can learn optimal slotting policies by simulating warehouse states and rewarding placements that minimize travel time and maximize accessibility. For instance, the DQN model may treat slotting as a Markov Decision Process (MDP), where states represent current inventory distributions, actions involve assigning items to slots, and rewards are based on reduced picking times. Additionally, or alternatively, the dynamic slotting 360 may be performed using clustering algorithms such as K-means to group frequently co-ordered items, analyzing vector embeddings of order histories to determine proximity-based placements.

Inputs for dynamic slotting 360 may include real-time and historical data streams, such as inventory levels from RFID sensors, past order trends extracted from transaction logs, warehouse layouts digitized as grid maps, and operational performance metrics like picker travel distances captured via motion sensors. The data streams may be preprocessed through feature engineering, normalizing values (e.g., scaling travel times between 0 and 1) and encoding categorical data (e.g., one-hot vectors for item categories), before being fed into the models.

Outputs from dynamic slotting 360 may include optimized slot assignments, generated as a mapping of items to physical locations within the warehouse along with relocation instructions for automated systems. These outputs interface with the data processing module 108 by triggering dynamic updates to the sequenced set of tasks, ensuring that picking paths reflect new slot configurations, and with the orchestration module 110 to initiate real-time movements via automated guided vehicles (AGVs). The interface between machine learning models used for dynamic slotting 360, the data processing module 108, and the orchestration module 110 may be facilitated through a microservices architecture. The dynamic slotting 360 exposes endpoints for querying optimal placements, allowing the data processing module 108 to incorporate slot data during task generation 306. The dynamic slotting 360 may use API calls or WebSocket protocols for seamless integration with the orchestration module 110.

Employing AI dynamic slotting 360 for the automated execution of light manufacturing tasks can provide various advantages. For example, dynamic slotting 360 may be employed to preemptively adjust upstream inventory positioning to ensure materials are readily available, reducing setup times for tasks such as wire stripping or assembly. Optimized slotting can minimize transport delays from storage to manufacturing stations, allowing the orchestration module 110 to schedule tighter sequences without risking bottlenecks. This can result in faster cycle times for automated dipping or twisting, as predictive outputs enable proactive calibration of machine parameters based on anticipated material flows.

The task orchestration 362 may leverage various machine learning modules, such as sequence-to-sequence (Seq2Seq) models, often implemented with Long Short-Term Memory (LSTM) networks, to generate and refine task sequences in real-time. The machine learning models used for task orchestration 362 may predict the most efficient order of operations by encoding input constraints into hidden states and decoding them into task flows. In some examples, graph neural networks (GNNs) may be incorporated to model task dependencies such as graphs, where nodes represent tasks and edges denote prerequisites, allowing the system to propagate updates across interconnected operations. Hybrid approaches combining reinforcement learning with supervised learning may be employed to ensure that task orchestration adapts to both immediate performance data and long-term trends.

Inputs for task orchestration 362 can include task-specific details like dependency graphs from the data processing module 108, real-time feedback from the orchestration module 110 including machine utilization rates and error logs, and/or augmented data such as order priorities and resource availability. The inputs may be processed as time-series data for sequential modeling. The inputs may be preprocessed to align with the model's requirements, such as normalizing utilization rates or encoding task dependencies into adjacency matrices.

Outputs from task orchestration 362 may include refined task sequences as ordered lists, resource allocations, and contingency plans, which can be communicated to the data processing module 108 for validation and/or to the orchestration module 110 for execution. The interface between machine learning models used for task orchestration 362, the data processing module 108, and the orchestration module 110 may be facilitated through a microservices architecture. The data processing module 108 may validate sequence updates via API calls. The orchestration module 110 may subscribe to event streams from task orchestration 362 using WebSocket protocols.

Employing AI task orchestration 362 for the automated execution of light manufacturing tasks can provide various advantages. The task orchestration 362 can enhance fault tolerance by rerouting resources if a predicted shortage occurs, prevent bottlenecks by predicting resource usage and rerouting resources, and/or dynamically inserting buffer tasks like machine idle modes to conserve energy, ultimately boosting overall warehouse productivity.

The models for AI task orchestration 362 may be trained using a supervised learning paradigm, where historical task sequences and their outcomes—such as completion times and error rates—are used as labeled data. Training datasets may be augmented with synthetic variations generated via techniques like SMOTE (Synthetic Minority Over-sampling Technique) to handle imbalanced scenarios, such as rare high-complexity orders, ensuring robust generalization. Once deployed, the models may undergo continuous training via online learning methods, incorporating real-time feedback from the order fulfillment process. Triggers for retraining may include significant deviations in KPIs, detected when actual execution times exceed predicted values by a threshold (e.g., 15%), prompting the system to fine-tune weights. This adaptive training loop may interface with the data processing module 108 by pulling aggregated logs and with the orchestration module 110 by accessing live sensor streams, allowing models to evolve without offline interruptions.

Integration of inputs and outputs of AI task orchestration 362 with the order fulfillment process may be event-driven, with dynamic task list generation triggered by events such as new order arrivals, detected anomalies from sensors, or threshold breaches in resource utilization (e.g., machine load >80%). Upon trigger, the AI task orchestration 362 may receive updated dependency and receive real-time streams from the orchestration module 110, generating outputs that are pushed as event notifications for immediate validation and execution.

The outputs generated by the AI task orchestration 362 models, such as updated task sequences, may be utilized by the orchestration module 110 to revise control signals sent to light manufacturing equipment, translating sequence changes into machine-specific commands. For example, if a refined sequence inserts a calibration step due to predicted downtime, the orchestration module 110 may adjust PLC parameters in real-time (e.g., halting a twisting machine and rerouting power to ensure seamless resumption), thereby maintaining production flow and precision.

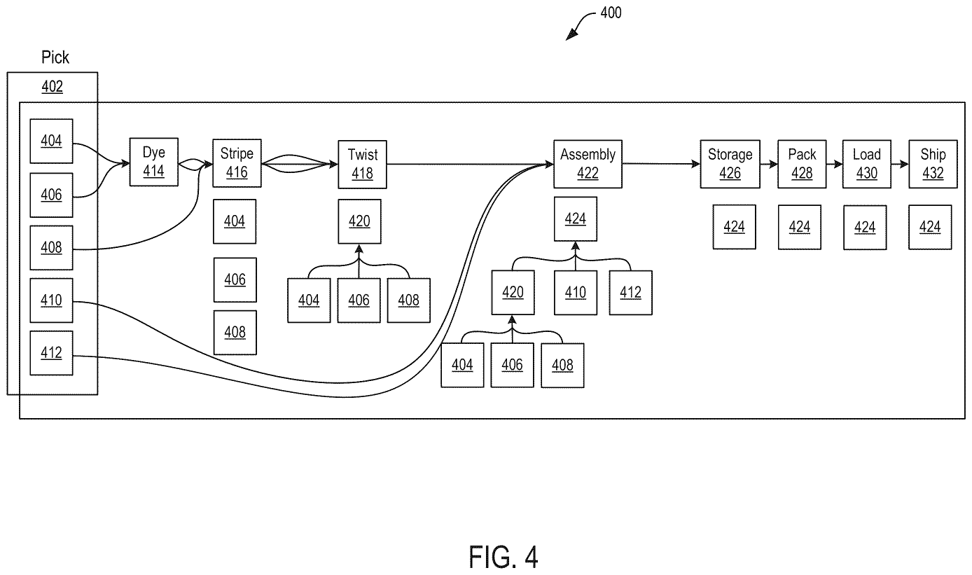

FIG. 4 illustrates a multi-level component assembly and delivery workflow 400, detailing steps for assembling Finished Goods #1 and #2. The process includes tasks such as “Pick,” “Dye,” “Stripe,” “Twist,” “Assembly,” “Storage,” “Pack,” “Load,” and “Ship.” Components like wires 404, 406, 408, cabinets 410, and fasteners 412 are selected from inventory 402 and processed through multi-level assembly to produce the final goods.

The wires 404, 406, 408 parameters include Part Identification (e.g., Wire 1, Wire 2, Wire 3), Part Number, Quantity, and Attributes such as: Vendor, Receipt Date, Reel Size, and Reel Material (plastic/wood). The cabinet 410 parameters include Part Identification (e.g., Cabinet), Part Number, Quantity, and Attributes such as: Receipt Date and Serial Number. The screws 412 parameters include Part Identification (e.g., Screws), Part Number, Quantity, and Attributes such as: Receipt Date and Lot Number. Each part is tagged for inventory and location tracking.

The assembly begins by picking the first and second wires 404, 406 from inventory 402 and transferred to the dye task 414 location. The third wire 408 is selected and transferred to the stripe task 416 location. The first and second wires 404, 406 are transferred from the dye task 414 location to the stripe task 416 location. From the stripe task 416 location all three wires 404, 406, 408 are transferred to the twist task 418 location, where the wires 404, 406, 408 are twisted to produce finished good #1 420.

Next, the cabinet 410 and screws 412 are picked from inventory 402 and transferred to the assembly task 422 location along with finished good #1 420. Finished good #1 420, the cabinet 410, and the screws 412 are assembled into finished good #2 424 at the assembly task 422 location. Finished good #2 424 is then transferred to the storage task 426, the pack task 428, the load task 430, and the ship task 432, where finished good #2 424 is shipped to the customer.

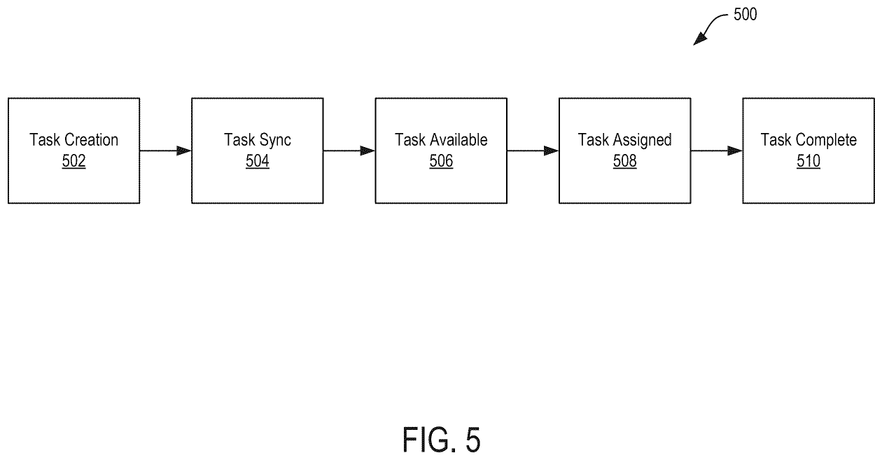

FIG. 5 shows a workflow 500 with task dependencies where certain prerequisites must be completed before proceeding to the next stage. For instance, picking wires 404 and 406 is required before starting the dye task 414. Each task follows a flow that includes task creation 502, synchronization 504, availability 506, assignment 508, and completion 510, triggering the next task upon completion.

With reference to FIG. 5 and FIG. 4, a new task state is created at the task creation stage 502. At the task sync stage 504, the system checks if any dependent tasks have been completed. For example, in FIG. 4, picking the first and second wires 404, 406 must be completed before the dye task 414 can be begin. The stripe task 416 cannot be completed until the inventory arrives. The three wires 404, 406, 408 must be stripped and transferred to the twist station before the twist task 418 becomes available. The end product from twisting the three wires 404, 406, 408 must be completed and transferred to the assembly station, as well as completion of picking the cabinet 410 and screws 412 from inventory before assembly can occur. At the task available stage 506 all material required to perform a task has arrived at the location to be performed. At the task assigned stage 508 an associate has confirmed receipt of the task and begins work. The associate catalogs any pertinent information about the task performed such as quantity picked, serial numbers, type and size of packaging material used, etc. At the task complete stage 510 the associate informs the system that the task is complete triggering the next task to perform.

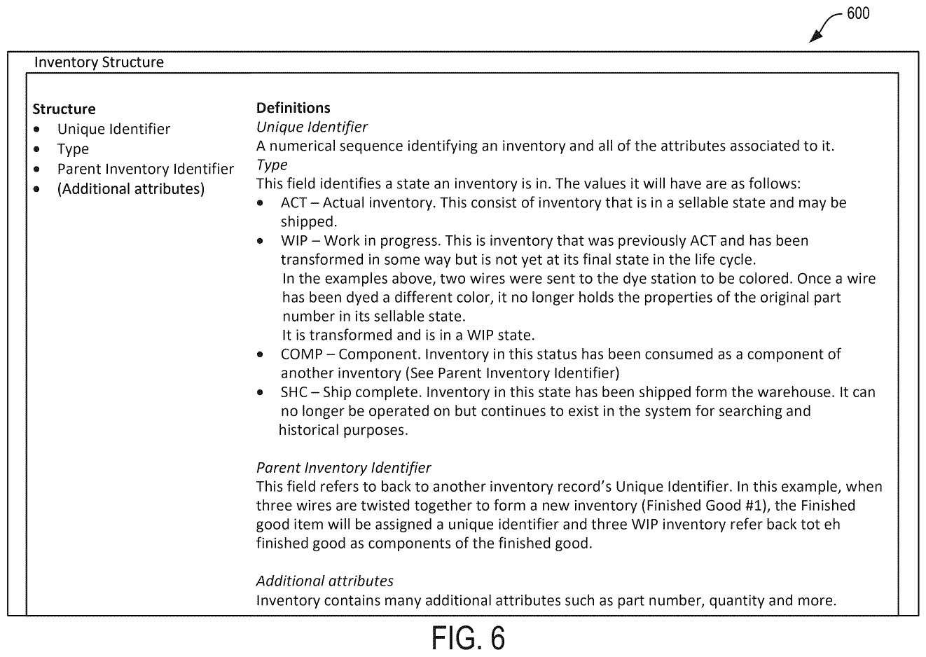

FIG. 6 displays an inventory structure 600 with attributes like Unique Identifier, Type, Parent Inventory Identifier, and additional inventory attributes. Types include Actual (ACT), Work in Progress (WIP), Component (COMP), and Ship Complete (SHC). Parent Inventory Identifiers link components to finished goods, ensuring full traceability across assembly stages. Completed items may be stored if finished before the target shipping date, ensuring efficient management and allocation of stock.

The Unique Identifier is a numerical sequence identifying an inventory and all of the attributes associated with it. ACT is an inventory that is in a sellable state. WIP inventory type is inventory that is transformed but not in its final state. COMP inventory type is inventory consumed as a component of another. SHC inventory type is inventory that is shipped and no longer operable. The Parent Inventory Identifier links components to a finished good, such as when three wires are twisted to form Finished Good #1. Additional inventory attributes include part number and quantity. Completed products are sent to storage if finished before the target ship date.

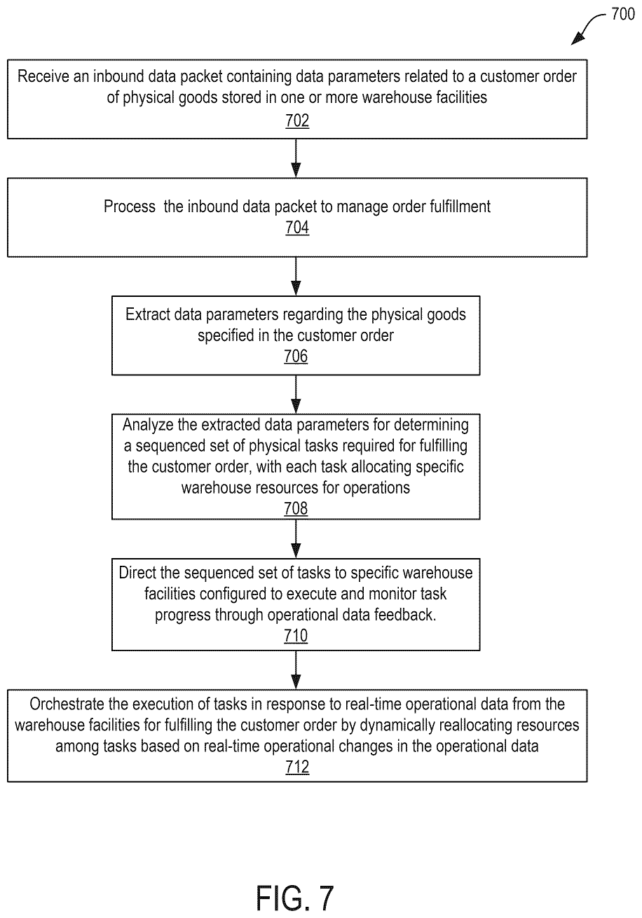

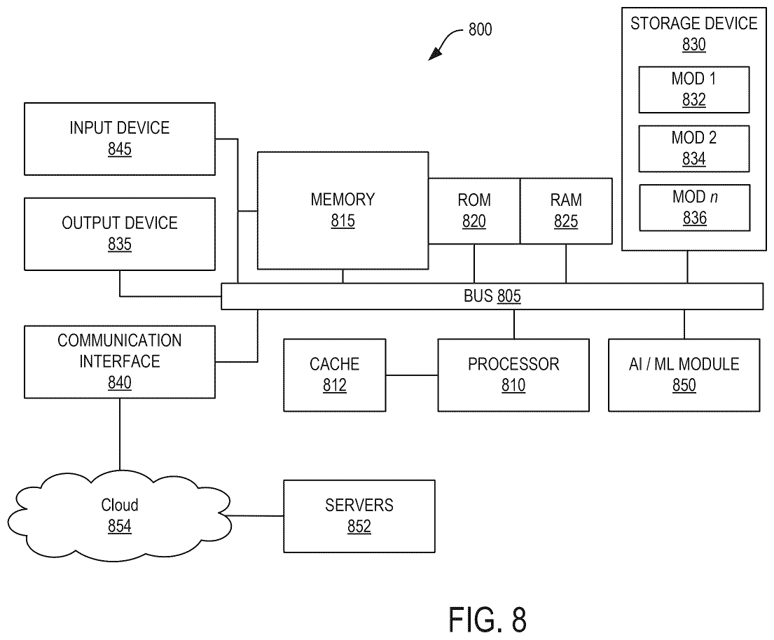

FIG. 7 is an embodiment of a computer-implemented method 700 for controlling operations within one or more warehouse facilities. In various embodiments, the computer-implemented method 700 may be executed within the warehouse management system architecture 100 depicted in FIG. 1 by the computing environment 800 depicted in FIG. 8. With reference to FIG. 7 together with FIG. 1, an input data module 106 receives 702 an inbound data packet containing data parameters related to a customer order of physical goods stored in one or more warehouse facilities. A data processing module 108 processes 704 the inbound data packet to manage order fulfillment. The data processing module 108 extracts 706 data parameters regarding the physical goods specified in the customer order; analyzes 708 the extracted data parameters for determining a sequenced set of physical tasks required for fulfilling the customer order, with each task allocating specific warehouse resources for operations; and directs 710 the sequenced set of tasks to specific warehouse facilities 118, 130, 132 to execute and monitor task progress through operational data feedback. The sequenced set of physical tasks may include automated light manufacturing tasks executable by the corresponding allocated warehouse resources. An orchestration module 110 to communicate with the data processing module 108, orchestrates 712 the execution of tasks in response to real-time operational data from the warehouse facilities 118, 130, 132, for fulfilling the customer order by dynamically reallocating resources among tasks based on real-time operational changes in the operational data.

In one embodiment, the automated light manufacturing tasks include one or more of cutting, stripping, twisting, printing, dipping, and multi-level component assembly. The orchestration module 110 may control execution of the automated light manufacturing tasks by transmitting machine-specific control signals to automated machines via programmable logic controller (PLC) interfaces.

In one embodiment, the parameters of the inbound data packet include order customization specifications for the customer order. The method 700 may include matching the customization specifications to the automated light manufacturing tasks. The method 700 may further include validating the automated light manufacturing tasks matched to the customization specification against automated machine capabilities and availability. The method 700 may further include constructing a dependency graph mapping inter-task dependencies between the validated automated light manufacturing tasks. The method 700 may further include determining the sequenced set of physical tasks based on the dependency graph.

In one embodiment, the method 700 includes applying a batching heuristic to group automated light manufacturing tasks across multiple customer orders based on shared customization specifications. The batching heuristic may use cosine similarity on vectorized order features to determine shared customization specifications. The method 700 may include determining the sequenced set of physical tasks based on the batching heuristic to minimize automated machine setting changes between execution of tasks across the multiple orders.

In one embodiment, the automated machines controlled by the orchestration module 100 may include any one or more of an automated computer numerical control (CNC) cutter for cutting tasks, a laser cutting machine for cutting tasks, an automated wire stripping machine for stripping tasks, an automated twisting machine for automated twisting tasks, an automated inkjet machine for printing tasks, an automated laser marking machine for printing tasks, an automated immersion dipping machine for dipping tasks, a robotic arm for multi-level component assembly tasks, and automated guided vehicles for multi-level component assembly tasks.

In one embodiment, the method 700 includes obtaining, by the orchestration module 110, the operational data from one or more sensors configured to monitor execution of the automated light manufacturing tasks by the automated machines.

In one embodiment, the method 700 includes detecting, by the orchestration module 110, an operational issue associated with execution of an automated light manufacturing task based on the operational data. The orchestration module 110 may dynamically modify execution of the automated light manufacturing tasks associated with operational issue in-real time to mitigate the operational issue. Dynamically modifying the execution may include modifying an operational parameter of the automated machine executing the automated light manufacturing task associated with operational issue. Dynamically modifying the execution may include allocating a different automated machine to the automated light manufacturing task associated with operational issue.

In one embodiment, the method 700 includes adjusting, by the orchestration module 110, the sequence of physical tasks determined by the data processing module 108 before directing the sequenced set of physical tasks to the specific warehouse facilities. The adjustment may be based on detecting a conflicting resource allocation with physical tasks associated with another customer order.

In one embodiment, the method 700 includes initiating, by the orchestration module 110, a startup sequence for one or more additional automated machines based on detecting a conflicting resource allocation with physical tasks associated with another customer order.

In one embodiment, the method 700 includes detecting, by the orchestration module 110, a triggering event based on the operational data. The triggering event may include one or more of a new order arrival, a detected anomaly associated with an automated machine, and a threshold breach associated with warehouse resource utilization. The orchestration module 110 may apply the operational data to a trained machine learning model to generate a refined task sequence for the sequenced set of physical tasks and transmit machine-specific control signals to automated machines to adjust execution of the automated light manufacturing tasks in real-time based on the refined task sequence.

In one embodiment, the method 700 includes obtaining, by an inventory optimization engine, dynamic slotting data inputs. The dynamic slotting data inputs may indicate any one or more of current inventory levels, past order trends, warehouse layouts, and performance metrics associated with picker travel distances. The inventor optimization engine may generate optimized slot assignments mapping items to physical locations within the warehouse facilities based on applying the dynamic slotting data to a machine learning model. Inventory positioning within the warehouse facilities may be adjusted based on the optimized slot assignments. For example, an AGV may automatically adjust inventory positioning according to the optimized slot assignment based on instructions from the orchestration module 110. The data processing module 108 may determine the sequenced set of physical tasks based on the adjusted inventory positioning.

In one embodiment, the data processing module 108 communicates data with an inventory module 112 to monitor inventory levels of the physical goods at one or more warehouse facilities; optimize storage locations of the physical goods and enhancing pick-path efficiency; and trace serialized components through stages of assembly, storage, and shipment. In another embodiment, the inventory module 112 adjusts the sequenced set of tasks based on real-time inventory levels at the one or more warehouse facilities, adapting tasks to match current stock availability.

In one embodiment, the data processing module 108 generates the sequenced set of tasks based on product-specific characteristics including at least one of assembly, labeling, or packaging requirements tailored to each product in the customer order.

In one embodiment, the data processing module 108 integrates data from external systems to dynamically adjust the sequenced set of tasks, fulfilling the customer order accurately and efficiently.

In one embodiment, the data processing module 108 applies predictive analytics based on historical operational data for proactively generating or adjusting the sequenced set of tasks to improve efficiency and prevent stock-outs.

In one embodiment, the data processing module 108 incorporates cross-docking processes into the sequenced set of tasks to directly transfer inbound goods to outbound shipping without intermediate storage, optimizing speed and reducing handling costs.

In one embodiment, the data processing module 108 creates the sequenced set of tasks for unique or custom orders that require different fulfillment paths, including coordination with multiple suppliers to provide a tailored and efficient customer order processing.

In one embodiment, the data processing module 108 generates the sequenced set of tasks based on customizable criteria, including urgency, delivery windows, or product perishability, for dynamically adjusting task execution to meet varying priorities.

In one embodiment, the data processing module 108 creates the sequenced set of tasks based on supplier availability, lead times, delivery routes, or supplier performance data, for optimizing supplier selection for timely and cost-effective order fulfillment.

In one embodiment, the orchestration module 110 adjusts or modifies the sequenced set of tasks based on the operational data received from each allocated warehouse facility.

In one embodiment, the orchestration module 110 prioritizes tasks in the sequenced set of tasks based on customer order-related criteria, including delivery deadlines, product perishability, or order value, to optimize fulfillment efficiency.

In one embodiment, the orchestration module 110 allocates tasks in the sequenced set of tasks to specific warehouse facilities based on geographic proximity to a delivery location or customer, for minimizing transportation time and costs.

In one embodiment, the orchestration module 110 modifies tasks in the sequenced set of tasks based on availability of workforce, equipment, or other operational resources at the warehouse facility, for optimizing capacity and reducing delays.

In one embodiment, the orchestration module 110 adjusts or triggers tasks in the sequenced set of tasks based on specific events, including stock replenishment, equipment malfunctions, or updates to customer orders.

In one embodiment, the orchestration module 110 customizes the sequenced set of tasks based on customer-specific preferences or requirements, including at least one of packaging, branding, or handling instructions provided in the inbound data packet.

In one embodiment, the orchestration module 110 detects failure or delay of a task in the sequenced set of tasks at a warehouse facility, and reallocating affected tasks to other warehouse facilities with available capacity or resources for maintaining operational efficiency.

In one embodiment, the orchestration module 110 optimizes the sequenced set of tasks based on energy consumption metrics, transportation distances, or equipment efficiency, for reducing overall environmental footprint of warehouse operations.

In one embodiment, the orchestration module 110 re-prioritizes tasks in the sequenced set of tasks based on detected delays or bottlenecks at one or more warehouse facilities to complete critical tasks first and meet customer deadlines.

In one embodiment, the orchestration module 110 optimizes the sequenced set of tasks based on geographical location of warehouse facilities relative to delivery destinations or supply chain nodes, for minimizing transportation distances and lead times.

In one embodiment, the orchestration module 110 allocates tasks in the sequenced set of tasks to one or more warehouse facilities based on inventory levels, workforce availability, transportation costs, or energy efficiency.

In one embodiment, the orchestration module 110 retrieves operational data from multiple external systems, including Warehouse Management Systems (WMS), Supply Chain Management (SCM) systems, or Enterprise Resource Planning (ERP) systems, for informing task generation and orchestration.

In one embodiment, the orchestration module 110 applies forecasting data based on historical operational performance to adjust the sequenced set of tasks based on predictive bottlenecks or resource constraints.

In one embodiment, the orchestration module 110 adjusts the sequenced set of tasks based on operational data related to equipment efficiency, including at least one of machinery performance metrics or downtime rates, for assigning tasks to the most capable and available equipment.

In one embodiment, the orchestration module 110 dynamically reallocates resources including workforce and machinery based on real-time operational data, for continuously optimizing the sequenced set of tasks to match available resources at each warehouse facility.

In one embodiment, a data output module 116 to communicate with the orchestration module 110 automatically generates and transmits notifications to customers regarding order status updates or delays based on operational data from warehouse facilities.

The disclosure now turns to FIG. 8 which illustrates an embodiment of a computing hardware environment 800 for advanced warehouse management. The computing hardware environment 800 is optimized for implementing the complex operations for warehouse management as described above in connection with FIGS. 1-7, integrating both a robust, modular hardware setup and a detailed processor-based computing system.

With reference to FIG. 8, the components of the system are in communication with each other using a system bus 805. The computing system 800 can include a processing unit (CPU or processor) 810 and a system bus 805 that may couple various system components including the system memory 815, such as read only memory (ROM) 820 and random-access memory (RAM) 825, to the processor 810. The computing system 800 can include a cache 812 of high-speed memory connected directly with, in close proximity to, or integrated as part of the processor 810.

The computing system 800 can copy data from the memory 815, ROM 820, RAM 825, and/or storage device 830 to the cache 812 for quick access by the processor 810. In this way, the cache 812 can provide a performance boost that avoids processor delays while waiting for data. These and other modules can control the processor 810 to perform various actions. Other system memory 815 may be available for use as well. The memory 815 can include multiple different types of memory with different performance characteristics. The processor 810 can include any general-purpose processor and a hardware module or software module, such as module 1 832, module 2 834, up to module n 836 (where n is an integer greater than 2) stored in the storage device 830, to control the processor 810 as well as a special-purpose processor where software instructions are incorporated into the actual processor design. The processor 810 may essentially be a completely self-contained computing system, containing multiple cores or processors, a system bus, memory controller, cache, etc. A multi-core processor may be symmetric or asymmetric.

To enable user interaction with the computing system 800, an input device 845 can represent any number of input mechanisms, such as a microphone for speech, a touch-protected screen for gesture or graphical input, keyboard, mouse, motion input, speech and so forth. An output device 835 can also be one or more of a number of output mechanisms known to those of skill in the art. In some instances, multimodal systems can enable a user to provide multiple types of input to communicate with the computing system 800. The communications interface 840 can govern and manage the user input and system output. There may be no restriction on operating on any particular hardware arrangement and therefore the basic features here may easily be substituted for improved hardware or firmware arrangements as they are developed.

The storage device 830 can be a non-volatile memory and can be a hard disk or other types of computer readable media which can store data that are accessible by a computer, such as magnetic cassettes, flash memory cards, solid state memory devices, digital versatile disks, cartridges, random access memory, read only memory, and hybrids thereof.

As discussed above, the storage device 830 can include the software modules 832, 834, 836 for controlling the processor 810. Other hardware or software modules are contemplated. The storage device 830 can be connected to the system bus 805. In some embodiments, a hardware module that performs a particular function can include a software component stored in a computer-readable medium in connection with the necessary hardware components, such as the processor 810, system bus 805, output device 835, and so forth, to carry out the function. For clarity of explanation, in some instances the present technology may be presented as including individual functional blocks including functional blocks comprising devices, device components, steps or routines in a method embodied in software, or combinations of hardware and software.

With reference to both FIG. 1 and FIG. 8, the disclosed warehouse management system 102 operates within a sophisticated, processor-based computing environment, exemplified by the computing system 800, designed to orchestrate, optimize, and secure warehouse operations with real-time precision. Central to the warehouse management system 102 is a high-performance processor 810, which coordinates essential functions across memory, storage, data inputs, and external networks via a system bus 805. Equipped with a dedicated cache 812, the processor 810 ensures rapid access and retrieval of critical data, minimizing latency and providing the computational capacity to process complex instructions related to task orchestration, inventory management, and order fulfillment including continuous AI-driven adjustments in task management, inventory tracking, and order fulfillment.

The computing system 800 includes a multi-tiered memory architecture where the system memory 815 includes both read-only memory 820 (ROM) and random-access memory 825 (RAM). One aspect of the computing system 800 is its multi-layered storage infrastructure, anchored by the storage device 830. This storage device 830 includes various forms of non-volatile memory, such as solid-state drives (SSDs) and magnetic storage, housing critical data and software modules 832, 834, 836 necessary for controlling the processor 810 and executing the warehouse management routines such as the modules 106, 108, 110, 112, 114, 116, described in FIG. 1, for example. The storage device 830 stores complex software algorithms and machine learning models that analyze historical data and real-time conditions, generating optimized task sequences for each warehouse facility.

This configuration supports high-speed processing for tasks and data updates essential for dynamic warehouse operations. While the ROM 820 provides core operational protocols and configurations, the high-speed RAM 825 enables the system to handle real-time updates to inventory levels, task queues, and predictive analytics. Furthermore, a storage device 830, including SSDs and magnetic storage, houses critical data and software modules necessary for executing warehouse management functions. This storage system retains historical records, operational data, and machine learning models, enabling complex task sequencing and optimized inventory management.

Artificial intelligence (AI) and machine learning (ML) modules 850 embedded within the computing system 800 enable advanced predictive analytics, transforming historical and real-time data into actionable insights. High-performance Tensor Processing Units (TPUs) and Graphical Processing Unites (GPUs), and Central Processing Units (CPUs) support continuous training of AI/ML models that enhance slotting optimization, pick-path efficiency, and demand forecasting. AI-driven algorithms analyze real-time operational data to anticipate potential stockouts, bottlenecks, or equipment failures, allowing the system to adjust task allocations proactively. These AI/ML models 850 are housed on cloud servers 852, enabling parallel processing and providing adaptive, scalable insights across warehouse facilities.

Leveraging TPUs, GPUs, and CPUs, the warehouse management system 102 continuously trains the ML models 850 that improve slotting optimization, pick-path efficiency, and demand forecasting, while factoring in complex variables like seasonality, lead times, and product perishability. AI-driven algorithms analyze real-time operational data to anticipate stockouts, bottlenecks, or equipment failures, to enable the system to proactively adjust task allocations and order priorities. These AI models are housed on cloud servers, where large datasets can be processed in parallel, providing scalable, adaptive insights to each warehouse facility.

To monitor and interact with the warehouse management system 102, warehouse facilities employ a suite of data collection and input/output (I/O) devices. Input devices 845, including barcode scanners, RFID readers, IoT sensors, touchscreens, and handheld devices, capture real-time data on inventory status, item locations, and environmental conditions. This data feeds into the processor 810 for seamless integration into the operational database, enabling precise, on-the-fly adjustments. Output devices, such as digital displays, wearable alerts, and screens, provide real-time feedback to personnel on inventory status and task priorities, ensuring that staff remain informed of critical updates and operational changes. The range of input and output devices, including the input device 845 and the output device 835, which enable warehouse personnel to interact directly with the warehouse management system 102. These devices 835, 845 provide real-time feedback and facilitate task monitoring, allowing operators to stay informed of task progress, inventory levels, and any system updates. Input devices 845, such as touchscreens and handheld scanners, capture real-time data from personnel and transmit it to the processor 810, while output devices 835 display prioritized task sequences, updates on order status, and notifications for operational adjustments.

To manage the complexities of warehouse orchestration by the orchestration module 119, the computing system 800 integrates a communications interface 840, which handles the flow of data between the processor 810 and other components, as well as external networks. The communications interface 840 supports and facilitates high-speed, bidirectional communication between the processor 810 and other system components such as other warehouse facilities 130, 132 and cloud-based resources, supporting data flows critical to real-time decision-making. This interface integrates with external systems 126 such as ERP, WMS, and SCM platforms, providing the system with comprehensive, up-to-date information for operational adjustments. For example, operational data from IoT sensors and RFID tags across the warehouse facilities 118, 130, 132 can be transmitted to the processor 810 in real time, updating the warehouse management system 102 on stock levels, item locations, and environmental conditions, to enable precise and timely adjustments to task sequences.

In various embodiments, the computing environment 800 is extended and supported by a scalable cloud-based infrastructure 854, which provides scalable storage, processing power, and data analytics. Cloud integration enables the warehouse management system 102 to store large volumes of historical data and compute-intensive ML models 850 remotely, ensuring each facility has access to centralized intelligence and enabling real-time processing for multiple locations simultaneously. This cloud framework, managed through virtual machines and containerized applications, allows for continuous software updates, enhanced disaster recovery, and rapid resource allocation based on system demand.

The scalable cloud-based infrastructure 854 also serves as the primary hub for inter-facility communication, linking regional warehouses to a central command system that monitors and directs tasks across the network. When additional processing capacity is required, the system can dynamically allocate cloud resources, ensuring that computational workloads related to predictive analytics, complex task sequencing, and resource optimization are handled efficiently. Additionally, data redundancy protocols within the cloud architecture safeguard operational data, ensuring recovery from hardware failure or data loss scenarios.

The processor-based computing system 800 operates within a cloud-enabled, modular hardware environment designed for scalability and high availability. This broader infrastructure includes additional AI-optimized processing units, such as TPUs and GPUs, which are capable of handling the intensive computational requirements of machine learning algorithms used for demand forecasting, slotting optimization, and real-time task adjustments. The modular cloud architecture ensures that each facility can access centralized data and processing power, dynamically adjusting workflows based on system demands. It also allows the orchestration module to allocate resources optimally, whether from central servers or distributed warehouse-specific processors, depending on task priorities and operational constraints.

The scalable cloud-based infrastructure 854 provides flexible storage, processing, and analytics capabilities across distributed facilities. Cloud integration supports storage of historical data, remote processing of compute-intensive machine learning models, and real-time data access for multiple warehouses. Managed through containerized applications and virtual machines, the cloud framework enables continuous software updates, enhanced disaster recovery, and dynamic resource allocation to accommodate varying operational demands. Cloud-based inter-facility communication ensures synchronized, efficient operations, with additional processing capacity allocated as needed.

Energy efficiency is also prioritized within the warehouse management system's 102 design, with power management protocols integrated across hardware components to reduce the system's environmental impact. The distributed power architecture, supported by uninterruptible power supplies (UPS) and backup generators, ensures reliable operation and minimizes downtime, allowing the system to maintain continuity and efficiency during power disruptions.

The warehouse management system's 102 security protocols ensure data integrity, privacy, and compliance with regulatory standards. These include end-to-end encryption, multi-factor authentication, role-based access control, and real-time monitoring via firewalls and intrusion detection systems. An AI-based anomaly detection component monitors access patterns and data consistency, flagging unusual activities. Additionally, encrypted logging and audit trails facilitate transparency and compliance with regulations such as GDPR for data privacy, while data sovereignty protocols ensure that sensitive information meets regional compliance standards.

This computing environment 800 represents an end-to-end, adaptive warehouse management platform that integrates AI-driven analytics, real-time data capture, robust security measures, and scalable cloud resources. The processor 810, memory modules, storage devices, and I/O components collectively enable data-driven decision-making, adjusting tasks in real time to respond to changing demands. Data flows seamlessly from cloud storage and I/O devices to the central processor, dynamically orchestrating resources to provide real-time updates to warehouse staff, maintain efficiency, and optimize performance across facilities. This robust, secure, and compliant system is designed to streamline operations, improve responsiveness, and support scalable growth in diverse logistics environments.

Altogether, the computing system 800 represents an end-to-end, adaptive warehouse management environment that combines AI-driven analytics, real-time data collection, secure data management, and scalable cloud resources to deliver exceptional operational efficiency. The processor 810, memory modules, storage devices, and I/O components work in concert to enable continuous, data-driven decision-making, adjusting warehouse tasks to meet evolving demands with precision. As data flows from the cloud 854 and various I/O devices to the central processor 810, the computing system 800 dynamically orchestrates resources, providing real-time updates to staff and ensuring optimal performance across warehouse facilities. This high-performance, secure, and compliant environment thus allows for streamlined operations, enhanced responsiveness to market demands, and scalable growth across diverse logistical challenges.

In summary, this integrated computing environment 800 offers a comprehensive solution for real-time warehouse management, combining high-performance processing, advanced memory configurations, scalable cloud-based resources, and robust communication interfaces. It enables efficient and adaptive control over the entire fulfillment process, from inventory monitoring and task allocation to predictive analytics and order prioritization, ultimately facilitating efficient and responsive warehouse operations that meet complex and changing logistical demands. Together, these elements establish a high-performance environment that supports continuous adaptation, precise task orchestration, and predictive optimization, fully realizing the functionalities described in the appended claims.

The presently disclosed warehouse management system 102 harnesses advanced artificial intelligence (AI) technologies, integrating sophisticated machine learning models with cutting-edge computational infrastructure to solve complex problems, enhance decision-making, and automate tasks across multiple warehouse facilities. Designed with flexibility, scalability, and high-performance in mind, the system offers organizations a comprehensive AI solution tailored to their needs.

At its core, the warehouse management system 102 utilizes a scalable, cloud-based architecture that ensures high availability, security, and performance even under the most demanding conditions. A distributed data processing pipeline allows the system to efficiently ingest, cleanse, and transform large volumes of structured and unstructured data in real-time, facilitating quick, intelligent insights.

The system warehouse management system 102 leverages state-of-the-art deep learning models such as convolutional neural networks (CNNs) for image analysis, recurrent neural networks (RNNs) for sequential data, and transformer models for natural language processing (NLP). These models are dynamically selected and optimized based on input data, ensuring the best possible outcomes for tasks like predictive analytics, image recognition, and language understanding.

Through reinforcement learning, the AI system continually learns and adapts in real-time, optimizing its performance over time. This feature enables autonomous decision-making in dynamic environments like robotics, autonomous vehicles, and operational workflows, where the system adjusts based on changing data or conditions.

In addition to cloud infrastructure, the warehouse management system 102 includes edge computing capabilities, enabling real-time AI processing on local devices or servers. This reduces latency and allows critical applications—such as IoT networks, autonomous systems, and real-time monitoring—to function seamlessly without relying on constant cloud communication.

Optimized for high-performance computing environments, the warehouse management system 102 utilizes GPUs and TPUs to accelerate machine learning tasks, enabling the rapid processing of large datasets. This feature is especially beneficial for applications requiring intense computational power, such as video analytics, financial modeling, and real-time data processing.

Built on a microservices framework, the AI system offers scalability and flexibility. Each AI function is deployed as an independent service, allowing organizations to scale and adjust components as necessary without affecting the entire system. This modularity ensures seamless updates and improvements over time.

The AI system integrates with real-time data streaming platforms like Apache Kafka and Apache Flink to process and analyze live data as it enters the system. This feature empowers businesses to make data-driven decisions in real-time, adapting quickly to new information and evolving market conditions.

Equipped with advanced NLP capabilities, the warehouse management system 102 comprehends, interprets, and generates human language. This enables applications like AI-driven customer service chatbots, sentiment analysis, and content generation, automating tasks that would otherwise require human input.

Built with security, the warehouse management system 102 features end-to-end encryption and adheres to the latest privacy regulations. It includes continuous monitoring for anomalous behavior, ensuring that sensitive data is securely processed and stored in compliance with industry standards.

The warehouse management system 102 can be deployed across a range of environments, including public or private cloud infrastructures (e.g., AWS, Azure, Google Cloud), hybrid cloud setups, or fully on-premise configurations. This flexibility allows organizations to select the best deployment strategy based on their operational, security, and scalability needs.

This AI based warehouse management system 102 represents a leap forward in intelligent technologies, combining adaptive learning, real-time data analytics, and advanced computing power to offer organizations unparalleled efficiency, accuracy, and insight. By seamlessly integrating AI into existing operations and adapting to diverse environments, this system empowers businesses to thrive in a rapidly evolving, data-driven world.

Within the context of this disclosure, the term “module” is used as a broad and flexible term to describe a component of the warehouse management system 102 that can be implemented using hardware, software, firmware, or a combination of these to perform one or more specific tasks or operations. A module may be implemented using various types of technology, including but not limited to:
1. Hardware: A physical device or circuit that executes predefined functions. Hardware modules may include, but are not limited to, processors (e.g., central processing units (CPUs), digital signal processors (DSPs), graphical processing units (GPUs)), memory components (RAM, ROM, flash memory), network interfaces, power management systems, or specialized chips such as application-specific integrated circuits (ASICs) or field-programmable gate arrays (FPGAs). These components may be connected through buses, networks, or communication interfaces, providing the necessary infrastructure for high-speed data transfer and execution of operations.
2. Software: A set of instructions stored in memory and executed by processing units. Software modules may include executable code, dynamic link libraries (DLLs), software development kits (SDKs), virtual machine environments, or applications. These modules are responsible for implementing algorithms, data processing, decision-making logic, and user interface functionalities. Software modules can be written in various programming languages (e.g., C++, Python, Java) and can interact with other modules through well-defined APIs, middleware, or cloud-based services.
3. Firmware: Low-level code stored in non-volatile memory (e.g., EEPROM, flash memory) that bridges the gap between hardware and higher-level software. Firmware modules provide the control logic necessary to configure, initialize, and manage hardware devices. Firmware can handle essential tasks such as device bootstrapping, protocol handling, and power management. Firmware updates may be delivered remotely, enabling post-deployment enhancements and security patches without requiring hardware modifications.

In addition to these core implementations, modules may include the following technical features:

Modules are capable of interacting with other modules via inter-module communication within the system through standard communication protocols such as Inter-Process Communication (IPC), message passing, remote procedure calls (RPC), or data buses. This allows for distributed operations across different hardware or software environments, whether local or over a network. The use of APIs, middleware layers, or network protocols (e.g., REST, gRPC) facilitates seamless communication between modules regardless of their underlying implementation.

Modules are designed with modularity and scalability features via a plug-and-play architecture, enabling the system to dynamically add, remove, or modify modules as needed. This modularity allows the system to scale efficiently, either horizontally (by adding more modules for parallel processing) or vertically (by enhancing the capabilities of individual modules). This feature is particularly useful in distributed computing environments, such as cloud platforms or multi-core processors.

Modules can be designed to support multi-threading, parallel execution, or distributed computing architectures, where tasks are split across multiple hardware resources (e.g., multi-core processors, distributed nodes). Load balancing and task synchronization mechanisms ensure efficient resource utilization, minimizing execution time for complex operations.

Modules can integrate AI-driven components such as machine learning models or neural networks to perform tasks like pattern recognition, decision-making, and predictive analytics. These AI modules can be pre-trained models or dynamically updated through continuous learning, depending on the application's requirements. Modules can leverage specialized AI hardware accelerators such as TPUs (Tensor Processing Units) or GPUs for high-performance processing.

For time-sensitive applications, modules may feature real-time processing capabilities, including low-latency processing, task prioritization, and event-driven architectures. Real-time operating systems (RTOS) or real-time task schedulers can be used within firmware or software modules to ensure that critical tasks are completed within specific time constraints.

Modules may incorporate security mechanisms such as encryption, authentication, and access control to protect data and ensure the integrity of operations. Secure hardware modules (e.g., Trusted Platform Modules (TPMs) or secure enclaves) may be used to store cryptographic keys and execute secure operations, while software-based modules may implement firewalls, intrusion detection systems (IDS), or secure communication protocols (e.g., TLS/SSL).

Modules may manage and store data using embedded databases, cloud storage services, or other data management and persistence mechanisms. Data synchronization across distributed systems may be supported through version control, replication strategies, and consistency models (e.g., eventual consistency, strong consistency).

Modules are adaptable for deployment in cloud environments (e.g., AWS, Google Cloud, Microsoft Azure) or edge computing frameworks. Cloud-based modules can dynamically scale according to demand, leveraging elastic resources, while edge modules perform low-latency processing closer to the data source, reducing dependency on centralized cloud systems.

In environments where power consumption is critical (e.g., IoT devices or battery-operated systems), modules may include energy-efficient designs, such as power-aware algorithms, dynamic voltage scaling, sleep modes, or energy harvesting technologies. Hardware modules may implement low-power designs using specific semiconductor technologies optimized for minimal energy usage.

Each module is designed to function as an independent, reusable component within a larger system architecture, while maintaining compatibility with other modules. This modular approach allows for flexibility in system design, enabling easy upgrades, extensions, and maintenance. Whether deployed on dedicated hardware, within virtualized environments, or across distributed networks, modules provide the foundational building blocks for the warehouse management system's 102 comprehensive functionality.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general-purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can comprise hardware, firmware and/or software, and can take any of a variety of form factors. Typical examples of such form factors include laptops, smart phones, small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

What is claimed is:

1. A computer-implemented method for controlling operations within one or more warehouse facilities, the method comprising:
receiving, by an input data module, an inbound data packet containing data parameters related to a customer order of physical goods stored in one or more warehouse facilities;
processing, by a data processing module, the inbound data packet to manage order fulfillment, wherein the data processing module is configured for:
extracting data parameters regarding the physical goods specified in the customer order;
analyzing the extracted data parameters for determining a sequenced set of physical tasks required for fulfilling the customer order, with each task allocating specific warehouse resources for operations, wherein the sequenced set of physical tasks comprise automated light manufacturing tasks executable by the corresponding allocated warehouse resources; and
directing the sequenced set of physical tasks to specific warehouse facilities configured to execute and monitor task progress through operational data feedback; and
orchestrating, by an orchestration module configured to communicate with the data processing module, the execution of tasks in response to operational data from the warehouse facilities for fulfilling the customer order by dynamically reallocating resources among the physical tasks based on operational changes in the operational data to adjust physical task execution in real-time.

2. The method of claim 1, wherein the automated light manufacturing tasks comprise one or more of cutting, stripping, twisting, printing, dipping, and multi-level component assembly, and wherein the orchestration module controls execution of the automated light manufacturing tasks by transmitting machine-specific control signals to automated machines via programmable logic controller (PLC) interfaces.

3. The method of claim 2, wherein the parameters of the inbound data packet comprise order customization specifications for the customer order, the method further comprising:
determining the automated light manufacturing tasks based on the customization specifications;
validating the determined automated light manufacturing tasks against automated machine capabilities and availability;
constructing a dependency graph mapping inter-task dependencies between the validated automated light manufacturing tasks; and
determining the sequenced set of physical tasks based on the dependency graph.

4. The method of claim 3, further comprising:
applying a batching heuristic to group automated light manufacturing tasks across multiple customer orders based on shared customization specifications, wherein the batching heuristic uses cosine similarity on vectorized order features; and
determining the sequenced set of physical tasks based on the batching heuristic to minimize automated machine setting changes between execution of tasks across the multiple orders.

5. The method of claim 2, wherein the automated machines controlled by the orchestration module comprise any one or more of an automated computer numerical control (CNC) cutter for cutting tasks, a laser cutting machine for cutting tasks, an automated wire stripping machine for stripping tasks, an automated twisting machine for automated twisting tasks, an automated inkjet machine for printing tasks, an automated laser marking machine for printing tasks, an automated immersion dipping machine for dipping tasks, a robotic arm for multi-level component assembly tasks, and automated guided vehicles for for multi-level component assembly tasks.

6. The method of claim 2, further comprising:
obtaining, by the orchestration module, the operational data from one or more sensors configured to monitor execution of the automated light manufacturing tasks by the automated machines;
detecting, by the orchestration module, an operational issue associated with execution of an automated light manufacturing task based on the operational data; and
dynamically modifying execution of the automated light manufacturing tasks associated with the operational issue in-real time to mitigate the operational issue, wherein dynamically modifying the execution comprises modifying an operational parameter of the automated machine executing the automated light manufacturing task associated with operational issue or allocating a different automated machine to the automated light manufacturing task associated with operational issue.

7. The method of claim 2, further comprising adjusting, by the orchestration module, the sequence of physical tasks determined by the data processing module before directing the sequenced set of physical tasks to the specific warehouse facilities for execution based on detecting a conflicting resource allocation with physical tasks associated with another customer order.

8. The method of claim 2, further comprising initiating, by the orchestration module, a startup sequence for one or more additional automated machines based on detecting a conflicting resource allocation with physical tasks associated with another customer order.

9. The method of claim 2, further comprising:
detecting, by the orchestration module, a triggering event based on the operational data, wherein the triggering event comprises one or more of a new order arrival, a detected anomaly associated with an automated machine, and a threshold breach associated with warehouse resource utilization;
applying, by the orchestration module, the operational data to a trained machine learning model to generate a refined task sequence for the sequenced set of physical tasks; and
transmitting machine-specific control signals to automated machines to adjust execution of the automated light manufacturing tasks in real-time based on the refined task sequence.

10. The method of claim 1, further comprising:
obtaining, by a inventory optimization engine, dynamic slotting data inputs indicating current inventory levels, past order trends, warehouse layouts, and performance metrics associated with picker travel distances;
generating, by the inventor optimization engine, optimized slot assignments mapping items to physical locations within the warehouse facilities based on applying the dynamic slotting data to a machine learning model;
automatically adjusting, by the orchestration module, inventory positioning within the warehouse facilities based on the optimized slot assignments; and
determining, by the data processing module, the sequenced set of physical tasks based on the adjusted inventory positioning.

11. The method of claim 1, wherein the data processing module is configured to communicate data with an inventory module, wherein the inventory module is configured for:
monitoring inventory levels of the physical goods at one or more warehouse facilities;
optimizing storage locations of the physical goods and enhancing pick-path efficiency; and
tracing serialized components through stages of assembly, storage, and shipment.

12. The method of claim 2, comprising adjusting, by the inventory module, the sequenced set of physical tasks based on real-time inventory levels at the one or more warehouse facilities, adapting physical tasks to match current stock availability.

13. The method of claim 1, comprising generating, by the data processing module, the sequenced set of physical tasks based on product-specific characteristics including at least one of assembly, labeling, or packaging requirements tailored to each product in the customer order.

14. The method of claim 1, comprising applying, by the data processing module, predictive analytics based on historical operational data for proactively generating or adjusting the sequenced set of physical tasks to improve efficiency and prevent stock-outs.

15. The method of claim 1, comprising adjusting or modifying, by the orchestration module, the sequenced set of physical tasks based on the operational data received from each allocated warehouse facility.

16. The method of claim 1, comprising prioritizing, by the orchestration module, physical tasks in the sequenced set of physical tasks based on customer order-related criteria, including delivery deadlines, product perishability, or order value, to optimize fulfillment efficiency.

17. A system for managing operations across one or more warehouse facilities, the system comprising:
an input data module configured to receive inbound data packets containing parameters associated with a customer order for physical goods stored at one or more warehouse facilities;
a data processing module comprising a processor and memory configured to execute instructions, wherein the data processing module is configured to:
extract data parameters from the inbound data packets related to the physical goods specified in the customer order;
analyze the extracted data to generate a sequenced set of physical tasks needed to fulfill the customer order, wherein the physical tasks are allocated to one or more warehouse facilities with each physical task allocating specific warehouse resources for task execution, and wherein the sequenced set of physical tasks comprise automated physical tasks executable by the corresponding allocated warehouse resources; and
transmit the sequenced set of physical tasks to the warehouse facilities;
a plurality of communication interfaces located at each warehouse facility, the communication interfaces configured to:
receive the sequenced set of physical tasks from the data processing unit; and
send operational data, including status updates, back to the data processing unit;
an orchestration module configured to receive the operational data and adjust the sequenced set of physical tasks in response to conditions at the warehouse facilities;
a storage system configured for dynamic storage and retrieval of goods, in communication with the orchestration module and the data processing unit, enabling optimization of goods location and retrieval paths within each warehouse facility based on the sequenced set of physical tasks; and
a tracking system comprising sensor arrays and inventory tagging mechanisms configured to track serialized components as they move through stages of assembly, storage, and shipment, and to communicate tracked data to the data processing unit, wherein the sensor arrays and inventory tracking mechanisms comprises at least one of RFID tracking or barcode systems.

18. The system of claim 17, wherein the automated light manufacturing tasks comprise one or more of cutting, stripping, twisting, printing, dipping, and multi-level component assembly.

19. The system of claim 17, comprising a cloud-based control module configured to support centralized operations across multiple warehouse facilities, enabling remote management, real-time data synchronization, and operational oversight from a single access point.

20. The system of claim 17, wherein the data processing module includes a predictive analytics engine configured to analyze historical data and forecast demand, enabling the orchestration module to proactively adjust the sequenced set of physical tasks to prevent stockouts and optimize resource allocation.

21. The system of claim 17, wherein the input data module is configured to receive data from external supply chain systems, including Supplier Management Systems and Logistics Systems, providing the data processing module with supply availability and lead time information to adjust task sequencing.

22. The system of claim 17, wherein the storage system is configured with modular storage units, which can be rearranged dynamically based on real-time inventory demands and are repositioned by an automated system to reduce retrieval time for frequently ordered goods.

23. The system of claim 17, comprising a machine learning module embedded in the data processing module, wherein the machine learning module continuously refines physical task sequencing based on real-time performance data, historical data, and evolving inventory patterns.

24. The system of claim 17, comprising an integration layer, configured to interface with third-party enterprise resource planning (ERP) systems, enabling the data processing module to access supplier data, order fulfillment metrics, and transportation schedules, to optimize the generated sequenced set of physical tasks.

25. A non-transitory computer-readable medium storing instructions that, when executed by one or more processors of a warehouse management system, cause the warehouse management system to manage operations across one or more warehouse facilities, the instructions comprising:
receiving, by an input data module, inbound data packets containing parameters associated with a customer order of physical goods stored at one or more warehouse facilities;
extracting data parameters from the inbound data packets related to the physical goods specified in the customer order;
analyzing the extracted data to determine a sequenced set of physical tasks required to fulfill the customer order, each task allocated to one or more of the warehouse facilities, wherein the sequenced set of physical tasks comprise automated physical tasks executable by warehouse resources at the one or more warehouse facilities;
transmitting the sequenced set of physical tasks to allocated warehouse facilities for execution; and
receiving operational data from each warehouse facility regarding task status, inventory levels, and order fulfillment progress; and
adjusting, by an orchestration module, the sequenced set of physical tasks based on the operational data received from the warehouse facilities to adjust physical task execution in real-time and improve order fulfillment accuracy and efficiency.

26. The non-transitory computer-readable medium of claim 25, wherein the instructions comprise communicating data, by the data processing module, with an inventory module configured for:
monitoring inventory levels of the physical goods across the warehouse facilities;
optimizing storage location of physical goods for efficient picking paths; and
tracing serialized components through stages of assembly, storage, and shipment.

27. The non-transitory computer-readable medium of claim 26, wherein the instructions comprise adjusting the sequenced set of physical tasks based on real-time inventory levels at the warehouse facilities, adapting physical tasks to current stock availability.

28. The non-transitory computer-readable medium of claim 25, wherein the instructions comprise generating the sequenced set of physical tasks based on product-specific characteristics, including at least one of assembly, labeling, or packaging requirements tailored to each item in the customer order.

29. The non-transitory computer-readable medium of claim 25, wherein the instructions comprise applying predictive analytics, based on historical operational data, to proactively generate or adjust the sequenced set of physical tasks to improve efficiency and prevent stock shortages.

30. The non-transitory computer-readable medium of claim 25, wherein the instructions comprise adjusting the sequenced set of physical tasks based on operational data received from allocated warehouse facilities to modify tasks dynamically and prioritizing tasks in the sequenced set of physical tasks based on criteria such as delivery deadlines, product perishability, or order value to optimize order fulfillment efficiency.
